(19) United States
(12) Patent Application Publication
(10) Pub. No.: US 2023/0033447 A1
(43) Pub. Date: Feb. 2, 2023

(54) DOUBLE-SIDED ADHESIVE TAPE

(71) Applicant: NITTO DENKO CORPORATION, Osaka (JP)

(72) Inventors: Yukihiro YAMASHITA, Ibaraki-shi (JP); Makoto SAITO, Ibaraki-shi (JP); Toru ISEKI, Ibaraki-shi (JP); Junji FUKUHARA, Ibaraki-shi (JP)

(73) Assignee: NITTO DENKO CORPORATION, Osaka (JP)

(21) Appl. No.: 17/768,297

(22) PCT Filed: Sep. 14, 2020
(86) PCT No.: PCT/JP2020/034694

§ 371 Date: Apr. 12, 2022

(30) Foreign Application Priority Data
Oct. 30, 2019 (JP) 2019-197006

(51) Int. Cl. C09J 7/38; C09J 7/29; C09J 7/22; B32B 27/08; B32B 27/32; B32B 27/30; B32B 27/40

(52) U.S. Cl. CPC C09J 7/385; C09J 7/29; C09J 7/22; B32B 27/08; B32B 27/32; B32B 27/306; B32B 27/302; B32B 27/40; B32B 2250/40; B32B 2250/242; B32B 2255/10; B32B 2255/26; B32B 2307/54; B32B 2307/732; B32B 2405/00

(57) ABSTRACT

Provided is a double-sided pressure-sensitive adhesive tape, which is excellent in initial pressure-sensitive adhesive property to an adherend, is sufficiently elongated, hardly breaks even when sufficiently elongated, can be smoothly pulled and removed from the adherend under an elongated state, and is excellent in reworking properties. The double-sided pressure-sensitive adhesive tape in an embodiment of the present invention includes, in this order: a pressure-sensitive adhesive layer (B1); a base material layer (A); and a pressure-sensitive adhesive layer (B2), wherein the pressure-sensitive adhesive layer (B1) and the pressure-sensitive adhesive layer (B2) each contain at least one kind selected from the group consisting of: an acrylic pressure-sensitive adhesive; and a rubber-based pressure-sensitive adhesive, and the acrylic pressure-sensitive adhesive contains a filler, wherein the base material layer (A) contains, as a resin component, at least one kind selected from the group consisting of: polyolefin; thermoplastic polyurethane; and a styrene-based polymer.

### TECHNICAL FIELD

The present invention relates to a double-sided pressure-sensitive adhesive tape.

### BACKGROUND ART

A double-sided pressure-sensitive adhesive tape has been utilized for fixing or temporarily fixing a part to be included in an electronic device, typically a mobile device, such as a cellular phone, a smartphone, or a tablet terminal.

The double-sided pressure-sensitive adhesive tape is required to show a predetermined or more pressure-sensitive adhesive strength so that an adhesive failure, such as peeling or a shift, may not occur during its use period.

Meanwhile, the double-sided pressure-sensitive adhesive tape may be removed from an adherend after having been bonded to the adherend. For example, there is a case in which an inconvenient rework has occurred in bonding the double-sided pressure-sensitive adhesive tape, and hence the rework needs to be performed after the peeling of the double-sided pressure-sensitive adhesive tape. In addition, for example, there is a case in which the double-sided pressure-sensitive adhesive tape needs to be peeled in order to, for example, repair, replace, inspect, or recycle a member including the adherend having bonded thereto the double-sided pressure-sensitive adhesive tape.

In a situation where the double-sided pressure-sensitive adhesive tape is used, for example, an adherend is present on at least one side of the double-sided pressure-sensitive adhesive tape, and typically, adherends are present on both the sides of the double-sided pressure-sensitive adhesive tape. Accordingly, to peel the double-sided pressure-sensitive adhesive tape from an adherend, when the adherends are present on both the sides of the double-sided pressure-sensitive adhesive tape, for example, the following needs to be performed. First, one of the adherends is turned from the other adherend to expose one surface of the double-sided pressure-sensitive adhesive tape, and then the double-sided pressure-sensitive adhesive tape is peeled. In addition, to peel the double-sided pressure-sensitive adhesive tape from an adherend, when the adherend is present on one side of the double-sided pressure-sensitive adhesive tape, for example, the double-sided pressure-sensitive adhesive tape needs to be carefully peeled from the adherend.

However, when an adherend is expensive, there is a high risk in that the performance of such turning work or peeling work as described above damages the adherend.

In view of the foregoing, the use of an extensible double-sided pressure-sensitive adhesive tape has been proposed as a method of peeling a double-sided pressure-sensitive adhesive tape from an adherend without performing such turning work as described above (e.g., Patent Literatures 1 to 6). A technical concept in the method is as described below. Part of the double-sided pressure-sensitive adhesive tape bonded to the adherend is held and pulled so that the double-sided pressure-sensitive adhesive tape may be elongated and deformed. A bonding area between the adherend and the tape is thus reduced to enable the removal of the tape from the adherend in a horizontal direction (shear direction).

However, the related-art extensible double-sided pressure-sensitive adhesive tape is poor in reworking properties because the tape involves a problem in that its peeling from the adherend is heavy, and hence the tape cannot be smoothly removed, and a problem in that the tape breaks during its removal through its elongation and deformation.

### CITATION LIST

### Patent Literature

[PTL 1] JP 2013-119564 A

[PTL 2] JP 2016-29155 A

[PTL 3] JP 2017-197689 A

[PTL 4] JP 2016-8288 A

[PTL 5] WO 2019/003933 A1

[PTL 6] JP 2019-6908 A

### SUMMARY OF INVENTION

### Technical Problem

An object of the present invention is to provide a double-sided pressure-sensitive adhesive tape, which is excellent in initial pressure-sensitive adhesive property to an adherend, is sufficiently elongated, hardly breaks even when sufficiently elongated, can be smoothly pulled and removed from the adherend under an elongated state, and is excellent in reworking properties.

### Solution to Problem

According to one embodiment of the present invention, there is provided a double-sided pressure-sensitive adhesive tape, including, in this order:

a pressure-sensitive adhesive layer (B1);

a base material layer (A); and

a pressure-sensitive adhesive layer (B2),

wherein the pressure-sensitive adhesive layer (B1) and the pressure-sensitive adhesive layer (B2) each contain at least one kind selected from the group consisting of: an acrylic pressure-sensitive adhesive; and a rubber-based pressure-sensitive adhesive, the acrylic pressure-sensitive adhesive containing a filler,

wherein the base material layer (A) contains, as a resin component, at least one kind selected from the group consisting of: polyolefin; thermoplastic polyurethane; and a styrene-based polymer,

wherein the pressure-sensitive adhesive layer (B1) and the pressure-sensitive adhesive layer (B2) each have an initial pressure-sensitive adhesive strength to a SUS plate of 5 N/10 mm or more at a peel angle of 180° and a peel rate of 300 mm/min under an environment at 23° C. and 50% RH, the initial pressure-sensitive adhesive strength being specified in JIS-Z-0237-2000, and

wherein the double-sided pressure-sensitive adhesive tape has an elongation at break of 600% or more, which is measured by a method of measuring an “elongation” specified in JIS-K-7311-1995.

In one embodiment, the double-sided pressure-sensitive adhesive tape according to the one embodiment of the present invention has a tensile strength of 12 N/10 mm or more at an elongation of 600%, the elongation being measured by the method of measuring an “elongation” specified in JIS-K-7311-1995.

In one embodiment, the base material layer (A) is a two-kind and three-layer type base material layer having a configuration “X layer/Y layer/X layer.”

In one embodiment, the two-kind and three-layer type base material layer is a two-kind and three-layer type base material layer having a layer configuration “polypropylene/ethylene-vinyl acetate copolymer/polypropylene,” or a two-kind and three-layer type base material layer having a layer configuration “polyethylene/polypropylene/polyethylene.”

In one embodiment, the double-sided pressure-sensitive adhesive tape according to the one embodiment of the present invention has a total thickness of from 100 μm to 700 μm.

In one embodiment, the base material layer (A) has a thickness of from 20 μm to 500 μm.

In one embodiment, the pressure-sensitive adhesive layer (B1) and the pressure-sensitive adhesive layer (B2) each have a thickness of from 10 μm to 200 μm.

In one embodiment, the double-sided pressure-sensitive adhesive tape according to the one embodiment of the present invention is used for an electronic device.

### Advantageous Effects of Invention

According to the present invention, the double-sided pressure-sensitive adhesive tape, which is excellent in initial pressure-sensitive adhesive property to an adherend, is sufficiently elongated, hardly breaks even when sufficiently elongated, can be smoothly pulled and removed from the adherend under an elongated state, and is excellent in reworking properties, can be provided.

### BRIEF DESCRIPTION OF DRAWINGS

FIG. 1 is a schematic sectional view of a double-sided pressure-sensitive adhesive tape according to one embodiment of the present invention.

FIG. 2(a), FIG. 2(b), and FIG. 2(c) are schematic side views for illustrating one mode of tensile removal from an adherend in which the double-sided pressure-sensitive adhesive tape according to the one embodiment of the present invention is used.

FIG. 3(a), FIG. 3(b), and FIG. 3(c) are schematic top views for illustrating one mode of the tensile removal from the adherend in which the double-sided pressure-sensitive adhesive tape according to the one embodiment of the present invention is used.

### DESCRIPTION OF EMBODIMENTS

When the expression “(meth)acrylic” is used herein, the expression means “acrylic and/or methacrylic,” and when the expression “(meth)acrylate” is used herein, the expression means “an acrylate and/or a methacrylate.”

### <<<<1. Double-Sided Pressure-Sensitive Adhesive Tape<<<<

A double-sided pressure-sensitive adhesive tape in an embodiment of the present invention may be a roll shape, or may be a sheet shape. The double-sided pressure-sensitive adhesive tape in the embodiment of the present invention may be such a form as to be processed into various shapes.

The double-sided pressure-sensitive adhesive tape in the embodiment of the present invention includes a pressure-sensitive adhesive layer (B1), a base material layer (A), and a pressure-sensitive adhesive layer (B2) in the stated order. The double-sided pressure-sensitive adhesive tape in the embodiment of the present invention may include any appropriate other layer to such an extent that the effects of the present invention are not impaired as long as the tape includes the pressure-sensitive adhesive layer (B1), the base material layer (A), and the pressure-sensitive adhesive layer (B2) in the stated order. The double-sided pressure-sensitive adhesive tape in the embodiment of the present invention typically has a configuration in which the pressure-sensitive adhesive layer (B1), the base material layer (A), and the pressure-sensitive adhesive layer (B2) are laminated in the stated order.

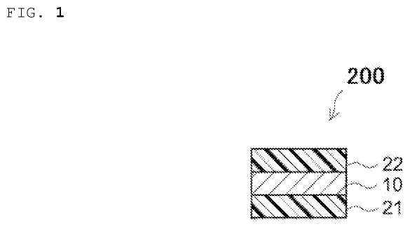

As illustrated in FIG. 1, typically, a double-sided pressure-sensitive adhesive tape 200 in the embodiment of the present invention includes a pressure-sensitive adhesive layer (B1) 21 on one surface side of a base material layer (A) 10, and includes a pressure-sensitive adhesive layer (B2) 22 on the other surface side of the base material layer (A).

A release liner may be arranged on each of the surface of the pressure-sensitive adhesive layer (B1) opposite to the base material layer (A) and the surface of the pressure-sensitive adhesive layer (B2) opposite to the base material layer (A) for protecting an exposed surface. Any appropriate release liner may be adopted as the release liner. Examples of such release liner include: a release liner having a release-treated layer on the surface of a liner base material, such as a resin film or paper; and a release liner formed of a low-adhesive material, such as a fluorine-based polymer (e.g., polytetrafluoroethylene) or a polyolefin-based resin (e.g., polyethylene (PE) or polypropylene (PP)). The release-treated layer may be, for example, a layer formed by treating the surface of the liner base material with a release treatment agent, such as a silicone-based release treatment agent, a long-chain alkyl-based release treatment agent, a fluorine-based release treatment agent, or a molybdenum sulfide release treatment agent.

The total thickness of the double-sided pressure-sensitive adhesive tape in the embodiment of the present invention is preferably from 100 μm to 700 μm, more preferably from 120 μm to 600 μm, still more preferably from 150 μm to 500 μm, particularly preferably from 200 μm to 450 μm. When the total thickness of the double-sided pressure-sensitive adhesive tape in the embodiment of the present invention falls within the ranges, both of a sufficient adhesive property and reworking properties can be achieved.

In the double-sided pressure-sensitive adhesive tape in the embodiment of the present invention, the thickness of the base material layer (A) is preferably from 20 μm to 500 μm, more preferably from 50 μm to 450 μm, still more preferably from 80 μm to 400 μm, particularly preferably from 90 μm to 350 μm. When the thickness of the base material layer (A) in the double-sided pressure-sensitive adhesive tape in the embodiment of the present invention falls within the ranges, the tape is sufficiently elongated, hardly breaks even when sufficiently elongated, and can be smoothly pulled and removed from an adherend under an elongated state.

In the double-sided pressure-sensitive adhesive tape in the embodiment of the present invention, the thickness of each of the pressure-sensitive adhesive layer (B1) and the pressure-sensitive adhesive layer (B2) is preferably from 10 μm to 200 μm, more preferably from 20 μm to 170 μm, still more preferably from 30 μm to 140 μm, particularly preferably from 40 μm to 110 μm. When the thickness of each of the pressure-sensitive adhesive layer (B1) and the pressure-sensitive adhesive layer (B2) in the double-sided pressure-sensitive adhesive tape in the embodiment of the present invention falls within the ranges, a sufficient adhesive property can be secured.

The double-sided pressure-sensitive adhesive tape in the embodiment of the present invention preferably has a long portion from the viewpoint of tensile removability. Thus, when, in the double-sided pressure-sensitive adhesive tape bonded to an adherend, one end of the portion formed into a long shape in its lengthwise direction is held and pulled, the double-sided pressure-sensitive adhesive tape can be preferably removed from the adherend. The shape of the long portion is typically a belt shape. The long portion may have a shape tapering toward one end in its lengthwise direction from the viewpoint of tensile removability. In a more preferred aspect, the entirety of the double-sided pressure-sensitive adhesive tape is formed into a long shape. A tab (holding portion) is preferably arranged on one end of the double-sided pressure-sensitive adhesive tape in its lengthwise direction from the viewpoint of tensile removal workability. Any appropriate shape may be adopted as the shape of the tab. An example of such shape is a shape that can be held with fingers (e.g., a rectangular shape).

In the double-sided pressure-sensitive adhesive tape in the embodiment of the present invention, the initial pressure-sensitive adhesive strength of each of the pressure-sensitive adhesive layer (B1) and the pressure-sensitive adhesive layer (B2) to a SUS plate at a peel angle of 180° and a peel rate of 300 mm/min under an environment at 23° C. and 50% RH, the initial pressure-sensitive adhesive strength being specified in JIS-Z-0237-2000, is preferably 5 N/10 mm or more, more preferably 8 N/10 mm or more, still more preferably 10 N/10 mm or more, particularly preferably 12 N/10 mm or more. When the initial pressure-sensitive adhesive strength falls within the ranges, the double-sided pressure-sensitive adhesive tape in the embodiment of the present invention is excellent in initial pressure-sensitive adhesive property to an adherend, and hence may be effectively utilized in, for example, the fixing or temporary fixing of a part to be included in an electronic device. The upper limit value of the initial pressure-sensitive adhesive strength is preferably 24 N/10 mm or less, more preferably 22 N/10 mm or less, still more preferably 20 N/10 mm or less, particularly preferably 18 N/10 mm or less. When the upper limit value of the initial pressure-sensitive adhesive strength is excessively high, the double-sided pressure-sensitive adhesive tape sticks to the adherend so strongly that there is a risk in that the effects of the present invention cannot be expressed.

In the double-sided pressure-sensitive adhesive tape in the embodiment of the present invention, the initial pressure-sensitive adhesive strength of each of the pressure-sensitive adhesive layer (B1) and the pressure-sensitive adhesive layer (B2) to a polypropylene (PP) plate at a peel angle of 180° and a peel rate of 300 mm/min under an environment at 23° C. and 50% RH, the initial pressure-sensitive adhesive strength being specified in JIS-Z-0237-2000, is preferably 1 N/10 mm or more, more preferably 1.5 N/10 mm or more, still more preferably 2 N/10 mm or more, particularly preferably 2.5 N/10 mm or more. When the initial pressure-sensitive adhesive strength falls within the ranges, the double-sided pressure-sensitive adhesive tape in the embodiment of the present invention is excellent in initial pressure-sensitive adhesive property to an adherend, in particular, initial pressure-sensitive adhesive property to a polyolefin-based adherend, and hence may be effectively utilized in, for example, the fixing or temporary fixing of a polyolefin-based part to be included in an electronic device. The upper limit value of the initial pressure-sensitive adhesive strength is preferably 24 N/10 mm or less, more preferably 22 N/10 mm or less, still more preferably 20 N/10 mm or less, particularly preferably 18 N/10 mm or less. When the upper limit value of the initial pressure-sensitive adhesive strength is excessively high, the double-sided pressure-sensitive adhesive tape sticks to the adherend so strongly that there is a risk in that the effects of the present invention cannot be expressed.

In the double-sided pressure-sensitive adhesive tape in the embodiment of the present invention, the initial pressure-sensitive adhesive strength of each of the pressure-sensitive adhesive layer (B1) and the pressure-sensitive adhesive layer (B2) to a polycarbonate plate at a peel angle of 180° and a peel rate of 300 mm/min under an environment at 23° C. and 50% RH, the initial pressure-sensitive adhesive strength being specified in JIS-Z-0237-2000, is preferably 5 N/10 mm or more, more preferably 8 N/10 mm or more, still more preferably 10 N/10 mm or more, particularly preferably 12 N/10 mm or more. When the initial pressure-sensitive adhesive strength falls within the ranges, the double-sided pressure-sensitive adhesive tape in the embodiment of the present invention is excellent in initial pressure-sensitive adhesive property to an adherend, in particular, initial pressure-sensitive adhesive property to a polycarbonate-based adherend, and hence may be effectively utilized in, for example, the fixing or temporary fixing of a polycarbonate-based part to be included in an electronic device. The upper limit value of the initial pressure-sensitive adhesive strength is preferably 24 N/10 mm or less, more preferably 22 N/10 mm or less, still more preferably 20 N/10 mm or less, particularly preferably 18 N/10 mm or less. When the upper limit value of the initial pressure-sensitive adhesive strength is excessively high, the double-sided pressure-sensitive adhesive tape sticks to the adherend so strongly that there is a risk in that the effects of the present invention cannot be expressed.

In the double-sided pressure-sensitive adhesive tape in the embodiment of the present invention, the initial pressure-sensitive adhesive strength of each of the pressure-sensitive adhesive layer (B1) and the pressure-sensitive adhesive layer (B2) to a copper (Cu) plate at a peel angle of 180° and a peel rate of 300 mm/min under an environment at 23° C. and 50% RH, the initial pressure-sensitive adhesive strength being specified in JIS-Z-0237-2000, is preferably 7 N/10 mm or more, more preferably 10 N/10 mm or more, still more preferably 11 N/10 mm or more, particularly preferably 13 N/10 mm or more. When the initial pressure-sensitive adhesive strength falls within the ranges, the double-sided pressure-sensitive adhesive tape in the embodiment of the present invention is excellent in initial pressure-sensitive adhesive property to an adherend, in particular, initial pressure-sensitive adhesive property to a copper-based adherend, and hence may be effectively utilized in, for example, the fixing or temporary fixing of a copper-based part to be included in an electronic device. The upper limit value of the initial pressure-sensitive adhesive strength is preferably 24 N/10 mm or less, more preferably 22 N/10 mm or less, still more preferably 20 N/10 mm or less, particularly preferably 18 N/10 mm or less. When the upper limit value of the initial pressure-sensitive adhesive strength is excessively high, the double-sided pressure-sensitive adhesive tape sticks to the adherend so strongly that there is a risk in that the effects of the present invention cannot be expressed.

The elongation at break of the double-sided pressure-sensitive adhesive tape in the embodiment of the present invention, which is measured by a method of measuring an “elongation” specified in JIS-K-7311-1995, is preferably 600% or more, more preferably 650% or more, still more preferably 700% or more, particularly preferably 750% or more, most preferably 800% or more. When the elongation at break falls within the ranges, the double-sided pressure-sensitive adhesive tape in the embodiment of the present invention is sufficiently elongated, and hardly breaks even when sufficiently elongated. The upper limit value of the elongation at break is preferably 2,500% or less from the viewpoint of expressing the effects of the present invention in a balanced manner.

The tensile strength of the double-sided pressure-sensitive adhesive tape in the embodiment of the present invention at an elongation of 600%, the elongation being measured by the method of measuring an “elongation” specified in JIS-K-7311-1995, is preferably 12 N/10 mm or more, more preferably 15 N/10 mm or more, still more preferably 20 N/10 mm or more, still more preferably 25 N/10 mm or more, still more preferably 30 N/10 mm or more, particularly preferably 35 N/10 mm or more, most preferably 40 N/10 mm or more. When the tensile strength at an elongation of 600% falls within the ranges, the tape more hardly breaks even when sufficiently elongated. The upper limit value of the tensile strength at an elongation of 600% is preferably 100 N/10 mm or less from the viewpoint of expressing the effects of the present invention in a balanced manner.

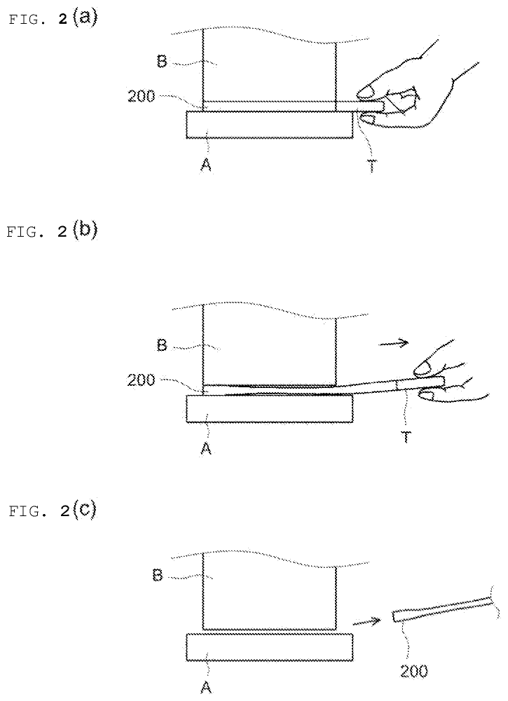

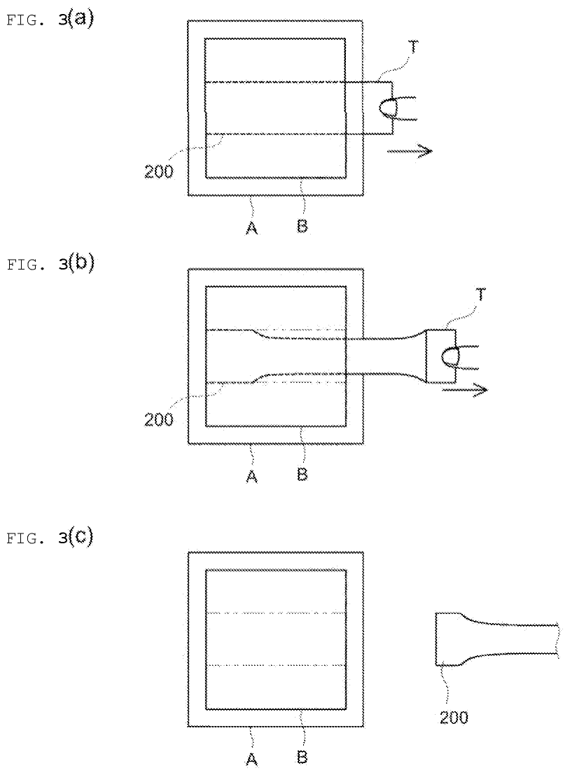

The double-sided pressure-sensitive adhesive tape in the embodiment of the present invention is preferably excellent in such performance as to be removed by being drawn from a space between adherends (drawing removability). The term “drawing removability” as used herein refers to the ease of such removal that: part of the double-sided pressure-sensitive adhesive tape (typically a tab) is exposed from the two adherends fixed via the double-sided pressure-sensitive adhesive tape; and the exposed site is pulled to draw the double-sided pressure-sensitive adhesive tape, thereby releasing the fixing (typically bonding) of the adherends. The two adherends may be the two sites of one member. The removal is specifically described below with reference to FIG. 2 and FIG. 3.

FIG. 2 are schematic side views for illustrating one mode of tensile removal (typically drawing removal). FIG. 2(a) is a view for illustrating a state in which the tensile removal of the double-sided pressure-sensitive adhesive tape is started, FIG. 2(b) is a view for illustrating a state in which the double-sided pressure-sensitive adhesive tape is pulled and removed, and FIG. 2(c) is a view for illustrating a state in which the tensile removal of the double-sided pressure-sensitive adhesive tape is completed. FIG. 3 are schematic top views for illustrating one mode of the tensile removal (typically drawing removal), and FIG. 3(a) to FIG. 3(c) are views corresponding to FIG. 2(a) to FIG. 2(c), respectively.

As illustrated in FIG. 2(a) and FIG. 3(a), in the double-sided pressure-sensitive adhesive tape 200, a tab T to be exposed to the outside at the time of the bonding of an adherend A and an adherend B is arranged. The adherend A and the adherend B are bonded to each other with the double-sided pressure-sensitive adhesive tape 200. Then, after the bonding object has been achieved, the tab T is pinched with fingers to pull the double-sided pressure-sensitive adhesive tape 200 so that the tape may be drawn from a space between the adherend A and the adherend B. In that case, the double-sided pressure-sensitive adhesive tape 200 starts to be elongated, and shrinks in a direction perpendicular to the direction in which the tape is pulled. Thus, the tape starts to be peeled from the adherend A and the adherend B (see FIG. 2(b) and FIG. 3(b)). Then, finally, the entire bonding region of the double-sided pressure-sensitive adhesive tape 200 is peeled, and hence the drawing of the double-sided pressure-sensitive adhesive tape 200 from the space between the adherend A and the adherend B is completed (see FIG. 2(c) and FIG. 3(c)). The removal of the adherend B bonded to the adherend A is simultaneously completed.

Such double-sided pressure-sensitive adhesive tape excellent in tensile removability is suitable for the fixing or temporary fixing of a part to be included in an electronic device, typically a mobile device, such as a cellular phone, a smartphone, or a tablet terminal. When the double-sided pressure-sensitive adhesive tape is used in, for example, the fixing or temporary fixing of a part to be included in an electronic device, the following cases may occur: a case in which an inconvenience has occurred in the work of bonding the double-sided pressure-sensitive adhesive tape, and hence the rework needs to be performed after the peeling of the double-sided pressure-sensitive adhesive tape; and a case in which the double-sided pressure-sensitive adhesive tape needs to be peeled in order to, for example, repair, replace, inspect, or recycle a member including an adherend having bonded thereto the double-sided pressure-sensitive adhesive tape. When the double-sided pressure-sensitive adhesive tape is used in, for example, the fixing or temporary fixing of the part to be included in an electronic device as described above, the frequency at which the double-sided pressure-sensitive adhesive tape is removed is particularly high. However, to peel the double-sided pressure-sensitive adhesive tape from an adherend, when the adherends are present on both the sides of the double-sided pressure-sensitive adhesive tape as illustrated in FIG. 2 and FIGS. 3, for example, the following needs to be performed: first, one of the adherends is turned from the other adherend to expose one surface of the double-sided pressure-sensitive adhesive tape; and then the double-sided pressure-sensitive adhesive tape is peeled. In addition, when the adherend is present on one side of the double-sided pressure-sensitive adhesive tape, for example, the double-sided pressure-sensitive adhesive tape needs to be carefully peeled from the adherend. However, the part to be included in an electronic device is often expensive, and hence the performance of such turning work or peeling work as described above involves a problem in terms of cost because there is a high risk in that the performance damages the part. The double-sided pressure-sensitive adhesive tape in the embodiment of the present invention is preferably excellent in tensile removability, and hence can be removed from the adherends in a horizontal direction (shear direction) as illustrated in FIG. 2 and FIG. 3. Accordingly, damage to the adherends resulting from the removal of the double-sided pressure-sensitive adhesive tape can be suppressed.

At the time of the removal of the double-sided pressure-sensitive adhesive tape, the tape cannot be removed from an adherend in the horizontal direction (shear direction) in many cases depending on the arrangement position of the adherend (e.g., the arrangement position of a part serving as an adherend in an electronic device). In such cases, the double-sided pressure-sensitive adhesive tape may be pulled and removed at any appropriate angle with respect to its pressure-sensitive adhesive surface to such an extent that the effects of the present invention are not impaired. The angle is, for example, preferably more than 0° and 90° or less, more preferably more than 0° and 45° or less, still more preferably more than 0° and 30° or less, particularly preferably more than 0° and 20° or less with respect to the horizontal direction (shear direction).

As a matter of course, the double-sided pressure-sensitive adhesive tape in the embodiment of the present invention may be utilized for a purpose except the fixing or temporary fixing of a part to be included in an electronic device as long as the tape can be effectively utilized for the purpose through the expression of the effects of the present invention. Examples thereof include: a building member, such as a wall surface or a pole; furniture; a household electric appliance; and a glass surface.

### <<1-1. Base Material Layer (A)>>

The base material layer (A) preferably contains, as a resin component, at least one kind selected from the group consisting of: polyolefin; thermoplastic polyurethane; and a styrene-based polymer in order that the effects of the present invention may be sufficiently expressed. The number of kinds of the resins in the base material layer (A) may be only one, or two or more.

The content of the resin component in the base material layer (A) is preferably from 50 wt % to 100 wt % because the effects of the present invention can be more sufficiently expressed, and the content is more preferably from 70 wt % to 100 wt %, still more preferably from 90 wt % to 100 wt %, still more preferably from 95 wt % to 100 wt %, particularly preferably from 98 wt % to 100 wt %, most preferably substantially 100 wt %.

Herein, a case described as “substantially 100 wt %” means that a trace amount of an impurity or the like may be incorporated to such an extent that the effects of the present invention are not impaired, and such case may be typically referred to as “100 wt %”.

Any appropriate polyolefin may be adopted as the polyolefin to such an extent that the effects of the present invention are not impaired. Such polyolefin is preferably at least one kind selected from the group consisting of: polyethylene; polypropylene; and polybutene-1 because the effects of the present invention can be more sufficiently expressed, and the polyolefin is more preferably at least one kind selected from the group consisting of: polyethylene; and polypropylene.

The polyethylene is, for example, at least one kind selected from the group consisting of: low-density polyethylene (LDPE); linear low-density polyethylene (LLDPE); ultralow-density polyethylene; medium-density polyethylene (MDPE); high-density polyethylene (HDPE); and ultrahigh-density polyethylene.

The polyethylene may be metallocene-catalyzed polyethylene obtained by using a metallocene catalyst. A commercial product may be adopted as the polyethylene.

The polypropylene is, for example, at least one kind selected from the group consisting of: random polypropylene; block polypropylene; and homopolypropylene.

The polypropylene may be metallocene-catalyzed polypropylene obtained by using a metallocene catalyst. A commercial product may be adopted as the polypropylene.

The polybutene-1 may be metallocene-catalyzed polybutene-1 obtained by using a metallocene catalyst. A commercial product may be adopted as the polybutene-1.

Any appropriate thermoplastic polyurethane may be adopted as the thermoplastic polyurethane to such an extent that the effects of the present invention are not impaired. An example of such thermoplastic polyurethane, which is generally called TPU, is a block copolymer containing a hard segment and a soft segment. Such thermoplastic polyurethane is preferably, for example, at least one kind selected from the group consisting of: polyester-based TPU; polyether-based TPU; and polycarbonate-based TPU because the effects of the present invention can be more sufficiently expressed.

A commercial product may be adopted as the thermoplastic polyurethane.

Any appropriate styrene-based polymer may be adopted as the styrene-based polymer to such an extent that the effects of the present invention are not impaired. Such styrene-based polymer is preferably, for example, a polymer containing a styrene-based thermoplastic elastomer because the effects of the present invention can be more sufficiently expressed.

Examples of the styrene-based thermoplastic elastomer include: AB-type block polymers, such as a hydrogenated styrene-butadiene rubber (HSBR), a styrene-based block copolymer or a hydrogenated product thereof, a styrene-butadiene copolymer (SB), a styrene-isoprene copolymer (SI), a copolymer of a styrene-ethylene-butylene copolymer (SEB), and a copolymer of a styrene-ethylene-propylene copolymer (SEP); styrene-based random copolymers such as a styrene-butadiene rubber (SBR); A-B-C-type styrene-olefin crystal-based block polymers such as a copolymer of a styrene-ethylene-butylene copolymer and an olefin crystal (SEBC); and hydrogenated products thereof. The styrene-based thermoplastic elastomer is preferably, for example, at least one kind selected from the group consisting of: a hydrogenated styrene-butadiene rubber (HSBR); and a styrene-based block copolymer or a hydrogenated product thereof because the effects of the present invention can be more sufficiently expressed.

Examples of the hydrogenated styrene-butadiene rubber (HSBR) include DYNARON 1320P, 1321P, and 2324P manufactured by JSR Corporation.

Examples of the styrene-based block copolymer include: styrene-based ABA-type block copolymers (triblock copolymers), such as a styrene-butadiene-styrene copolymer (SBS) and a styrene-isoprene-styrene copolymer (SIS); styrene-based ABAB-type block copolymers (tetrablock copolymers), such as a styrene-butadiene-styrene-butadiene copolymer (SBSB) and a styrene-isoprene-styrene-isoprene copolymer (SISI); styrene-based ABABA-type block copolymers (pentablock copolymers), such as a styrene-butadiene-styrene-butadiene-styrene copolymer (SBSBS) and a styrene-isoprene-styrene-isoprene-styrene copolymer (SISIS); and styrene-based block copolymers each having a larger number of AB repeating units.

Examples of the hydrogenated product of the styrene-based block copolymer include a styrene-ethylene-butylene copolymer-styrene copolymer (SEBS), a styrene-ethylene-propylene copolymer-styrene copolymer (SEPS), and a copolymer of a styrene-ethylene-butylene copolymer and a styrene-ethylene-butylene copolymer (SEBSEB).

Examples of the styrene-ethylene-butylene copolymer-styrene copolymer (SEBS) include DYNARON 8601P and 9901P manufactured by JSR Corporation.

A styrene content in the styrene-based thermoplastic elastomer (styrene block content in the case of the styrene-based block copolymer) is preferably from 1 wt % to 40 wt % because the effects of the present invention can be more sufficiently expressed, and the content is more preferably from 5 wt % to 40 wt %, still more preferably from 7 wt % to 30 wt %, still more preferably from 9 wt % to 20 wt %, particularly preferably from 9 wt % to 15 wt %, most preferably from 9 wt % to 13 wt %.

A hydrogenated product of a styrene-based block copolymer (e.g., a SEBS, a SEBSEB, or a SEBSEBS) having a repeating structure (e.g., an ABA type, an ABAB type, or an ABABA type) corresponding to a triblock copolymer or more formed of styrene (A) and butadiene (B) is suitable as the styrene-based thermoplastic elastomer because the effects of the present invention can be more sufficiently expressed.

When the styrene-based thermoplastic elastomer is a hydrogenated product of a styrene-based block copolymer (e.g., a SEBS, a SEBSEB, or a SEBSEBS) having a repeating structure (e.g., an ABA type, an ABAB type, or an ABABA type) corresponding to a triblock copolymer or more formed of styrene (A) and butadiene (B), the ratio of a butylene structure in an ethylene-butylene copolymer block is preferably 60 wt % or more because the effects of the present invention can be more sufficiently expressed, and the ratio is more preferably 70 wt % or more, still more preferably 75 wt % or more. The ratio of the butylene structure in the ethylene-butylene copolymer block is preferably 90 wt % or less.

The styrene-based polymer may contain any appropriate other polymer except the styrene-based polymer to such an extent that the effects of the present invention are not impaired. Examples of such other polymer include an ethylene/vinyl acetate copolymer, an ethylene/acrylic acid copolymer, an ethylene/methacrylic acid copolymer, an ethylene/acrylic acid ester copolymer, an ethylene/methacrylic acid ester copolymer, an ethylene/butene-1 copolymer, an ethylene/propylene/butene-1 copolymer, a copolymer of ethylene and an α-olefin having 5 to 12 carbon atoms, and an ethylene/non-conjugated diene copolymer. Of those, an ethylene/vinyl acetate copolymer is preferred.

A preferred embodiment of the styrene-based polymer is, for example, a blend product of a hydrogenated product of a styrene-based block copolymer (e.g., a SEBS, a SEBSEB, or a SEBSEBS) and an ethylene/vinyl acetate copolymer, and the embodiment is preferably, for example, a blend product of a SEBS and an ethylene/vinyl acetate copolymer because the effects of the present invention can be more sufficiently expressed.

The base material layer (A) may be formed of one layer (single layer), or two or more layers (a plurality of layers). A preferred embodiment in the case where the base material layer (A) is formed of two or more layers (a plurality of layers) is a two-kind and three-layer type base material layer having the configuration “X layer/Y layer/X layer” because the effects of the present invention can be more sufficiently expressed. The term “two-kind and three-layer type base material layer having the configuration “X layer/Y layer/X layer”” as used herein refers to a two-kind and three-layer type base material layer formed by laminating an X layer, a Y layer, and another X layer in the stated order.

When the base material layer (A) is a two-kind and three-layer type base material layer having the configuration “X layer/Y layer/X layer,” any appropriate ratio may be adopted as a ratio among the thicknesses of these three layers to such an extent that the effects of the present invention are not impaired. Such ratio is preferably (from 40% to 45%)/(from 35% to 85%)/(from 40% to 45%), more preferably (from 10% to 30%)/(from 40% to 80%)/(from 10% to 30%), still more preferably (from 12.5% to 27.5%)/(from 45% to 75%)/(from 12.5% to 27.5%), particularly preferably (from 15% to 25%)/(from 50% to 70%)/(from 15% to 25%) in terms of thickness ratio “X layer/Y layer/X layer” because the effects of the present invention can be more sufficiently expressed.

When the base material layer (A) is a two-kind and three-layer type base material layer having the configuration “X layer/Y layer/X layer,” specific examples thereof include the following layers because the effects of the present invention can be more sufficiently expressed: a two-kind and three-layer type base material layer having the layer configuration “polypropylene/ethylene-vinyl acetate copolymer/polypropylene” (two-kind and three-layer type base material layer formed by laminating a polypropylene layer, an ethylene-vinyl acetate copolymer layer, and another polypropylene layer in the stated order); and a two-kind and three-layer type base material layer having the layer configuration “polyethylene/polypropylene/polyethylene (two-kind and three-layer type base material layer formed by laminating a polyethylene layer, a polypropylene layer, and another polyethylene layer in the stated order).

The base material layer (A) may contain any appropriate additive as required. Examples of the additive that may be incorporated into the base material layer (A) include a release agent, a UV absorber, a heat stabilizer, a filler, a lubricant, a colorant (e.g., a dye), an antioxidant, an anti-build up agent, an anti-blocking agent, a foaming agent, and polyethyleneimine. The number of kinds of those additives may be only one, or two or more. The content of the additive in the base material layer (A) is preferably 10 wt % or less, more preferably 7 wt % or less, still more preferably 5 wt % or less, particularly preferably 2 wt % or less, most preferably 1 wt % or less.

Examples of the release agent include: a fatty acid amide-based release agent; a silicone-based release agent; a fluorine-based release agent; and a long-chain alkyl-based release agent. Of those, a fatty acid amide-based release agent is preferred from the viewpoint that a peeling layer that is more excellent in balance between peelability and resistance to contamination due to bleedout can be formed, and a saturated fatty acid bisamide is more preferred. Any appropriate content may be adopted as the content of the release agent. Typically, the content is preferably from 0.01 wt % to 5 wt % with respect to the resin component in the base material layer (A).

Examples of the UV absorber include a benzotriazole-based compound, a benzophenone-based compound, and a benzoate-based compound. Any appropriate content may be adopted as the content of the UV absorber as long as the absorber does not bleed out at the time of the forming of the base material layer (A). Typically, the content is preferably from 0.01 wt % to 5 wt % with respect to the resin component in the base material layer (A).

Examples of the heat stabilizer include a hindered amine-based compound, a phosphorus-based compound, and a cyanoacrylate-based compound. Any appropriate content may be adopted as the content of the heat stabilizer as long as the stabilizer does not bleed out at the time of the forming of the base material layer (A). Typically, the content is preferably from 0.01 wt % to 5 wt % with respect to the resin component in the base material layer (A).

Examples of the filler include inorganic fillers, such as talc, titanium oxide, calcium oxide, magnesium oxide, zinc oxide, calcium carbonate, silica, clay, mica, barium sulfate, whisker, and magnesium hydroxide. The average particle diameter of the filler is preferably from 0.1 μm to 20 μm. Any appropriate content may be adopted as the content of the filler. Typically, the content is preferably from 1 wt % to 200 wt % with respect to the resin component in the base material layer (A).

### <<1-2. Pressure-Sensitive Adhesive Layer (B1) and Pressure-Sensitive Adhesive Layer (B2)>>

Each of the pressure-sensitive adhesive layer (B1) and the pressure-sensitive adhesive layer (B2) may be formed of one layer (a single layer), or two or more layers (a plurality of layers). When the pressure-sensitive adhesive layer (B1) or the pressure-sensitive adhesive layer (B2) is formed of two or more layers (a plurality of layers), the respective layers may be layers formed of the same composition, or at least one of the layers may be a layer different in composition from the other layers.

The pressure-sensitive adhesive layer (B1) and the pressure-sensitive adhesive layer (B2) may be layers formed of the same composition, or layers formed of different compositions. In view of the ease of production and cost, the pressure-sensitive adhesive layer (B1) and the pressure-sensitive adhesive layer (B2) are preferably layers formed of the same composition.

In the present invention, the description of the pressure-sensitive adhesive layer (B1) and that of the pressure-sensitive adhesive layer (B2) have something in common, and hence in the description of the pressure-sensitive adhesive layer (B1) and the pressure-sensitive adhesive layer (B2), the layers may each be simply referred to as “pressure-sensitive adhesive layer (B),” the term serving as a concept including both the layers.

A pressure-sensitive adhesive layer including any appropriate pressure-sensitive adhesive may be adopted as the pressure-sensitive adhesive layer (B). Such pressure-sensitive adhesive is typically formed from a pressure-sensitive adhesive composition containing a base polymer. The term “base polymer” refers to the main component of a polymer component in the pressure-sensitive adhesive composition (typically a component to be incorporated at more than 50 wt %).

Any appropriate pressure-sensitive adhesive may be adopted as the pressure-sensitive adhesive for forming the pressure-sensitive adhesive layer (B) to such an extent that the effects of the present invention are not impaired. A preferred example of such pressure-sensitive adhesive is at least one kind selected from the group consisting of: an acrylic pressure-sensitive adhesive; and a rubber-based pressure-sensitive adhesive.

### <1-2-1. Acrylic Pressure-Sensitive Adhesive>

One embodiment of the pressure-sensitive adhesive layer (B) is an acrylic pressure-sensitive adhesive containing an acrylic polymer as the main component (base polymer) of its polymer component. That is, the main component (base polymer) of the polymer component in a pressure-sensitive adhesive composition for forming the acrylic pressure-sensitive adhesive is the acrylic polymer.

The content of the polymer component (containing the acrylic polymer as its base polymer) in the pressure-sensitive adhesive composition for forming the acrylic pressure-sensitive adhesive is preferably from 35 wt % to 85 wt %, more preferably from 40 wt % to 80 wt %, still more preferably from 45 wt % to 75 wt %, particularly preferably from 50 wt % to 70 wt % with respect to 100 wt % of the pressure-sensitive adhesive composition.

### (1-2-1-1. Polymer Component)

The content of the acrylic polymer serving as the base polymer in the polymer component in the pressure-sensitive adhesive composition for forming the acrylic pressure-sensitive adhesive is preferably from 50 wt % to 100 wt %, more preferably from 70 wt % to 100 wt %, still more preferably from 80 wt % to 100 wt %, particularly preferably from 90 wt % to 100 wt % with respect to 100 wt % of the polymer component.

A polymerized product of a monomer composition, which contains an alkyl (meth)acrylate as a main monomer and may further contain a sub-monomer having copolymerizability with the main monomer, is preferred as the acrylic polymer. The lower limit value of the content of the alkyl (meth)acrylate is preferably more than 50 wt %, more preferably 70 wt % or more, still more preferably 85 wt % or more, particularly preferably 90 wt % or more with respect to 100 wt % of all monomer components. The upper limit value of the content of the alkyl (meth)acrylate is preferably 99.5 wt % or less, more preferably 99 wt % or less with respect to 100 wt % of all the monomer components.

The number of kinds of the alkyl (meth)acrylates may be only one, or two or more.

An example of the alkyl (meth)acrylate is a compound represented by the general formula (1).

CH₂═C(R¹)COOR² (1)

In the general formula (1), R¹ represents a hydrogen atom or a methyl group, and R² represents an alkyl group having 1 to 20 carbon atoms.

R¹ preferably represents a hydrogen atom because the effects of the present invention can be more sufficiently expressed.

R² represents preferably an alkyl group having 1 to 14 carbon atoms, more preferably an alkyl group having 2 to 10 carbon atoms, still more preferably an alkyl group having 2 to 8 carbon atoms, particularly preferably an alkyl group having 4 to 8 carbon atoms because the effects of the present invention can be more sufficiently expressed. The alkyl group may be linear or branched.

Examples of the alkyl (meth)acrylate include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth) acrylate, 2-ethylhexyl (meth) acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth) acrylate, hexadecyl (meth) acrylate, heptadecyl (meth) acrylate, octadecyl (meth) acrylate, isostearyl (meth)acrylate, nonadecyl (meth)acrylate, and eicosyl (meth) acrylate.

The alkyl (meth)acrylate is preferably, for example, at least one kind selected from the group consisting of: n-butyl acrylate (BA); and 2-ethylhexyl acrylate (2EHA) because the effects of the present invention can be more sufficiently expressed, and the (meth)acrylate is more preferably n-butyl acrylate (BA) from the viewpoints of, for example, a pressure-sensitive adhesive characteristic and the prevention of an adhesive residue.

When such an alkyl (meth)acrylate that in the general formula (1), R¹ represents a hydrogen atom and R² represents an alkyl group having 4 to 8 carbon atoms (sometimes referred to as “C4-8 alkyl acrylate”) is used as the alkyl (meth)acrylate, the content of the C4-8 alkyl acrylate in the entire alkyl (meth)acrylate in all the monomer components is preferably from 70 wt % to 100 wt %, more preferably from 80 wt % to 100 wt %, still more preferably from 90 wt % to 100 wt %, particularly preferably from 95 wt % to 100 wt %, most preferably substantially 100 wt % with respect to 100 wt % of the entire alkyl (meth)acrylate because the effects of the present invention can be more sufficiently expressed.

The sub-monomer has copolymerizability with the alkyl (meth)acrylate serving as the main monomer, and may be useful in introducing a cross-linking point into the acrylic polymer or improving the cohesive strength of the acrylic polymer.

Examples of the sub-monomer include functional group-containing monomers, such as a carboxy group-containing monomer, a hydroxy group-containing monomer, an acid anhydride group-containing monomer, an amide group-containing monomer, an amino group-containing monomer, a keto group-containing monomer, a monomer having a nitrogen atom-containing ring, an alkoxysilyl group-containing monomer, an imide group-containing monomer, and an epoxy group-containing monomer. The sub-monomer is preferably at least one kind selected from the group consisting of: a carboxy group-containing monomer; and a hydroxy group-containing monomer because the effects of the present invention can be more sufficiently expressed.

The number of kinds of the sub-monomers may be only one, or two or more.

The carboxy group-containing monomer is preferably, for example, at least one kind selected from the group consisting of: acrylic acid (AA); and methacrylic acid (MAA) because the effects of the present invention can be more sufficiently expressed, and the monomer is more preferably acrylic acid (AA).

Examples of the hydroxy group-containing monomer include: hydroxyalkyl (meth)acrylates, such as 2-hydroxyethyl (meth) acrylate, 2-hydroxypropyl (meth)acrylate, 3-hydroxypropyl (meth)acrylate, 2-hydroxybutyl (meth)acrylate, and 4-hydroxybutyl (meth)acrylate; and unsaturated alcohols. Of those, hydroxyalkyl (meth)acrylates are preferred because the effects of the present invention can be more sufficiently expressed, and at least one kind selected from the group consisting of: 2-hydroxyethyl acrylate (HEA); and 4-hydroxybutyl acrylate (4HBA) is more preferred.

Examples of the acid anhydride group-containing monomer include maleic anhydride, itaconic anhydride, and an acid anhydride of the above-mentioned carboxy group-containing monomer.

Examples of the amide group-containing monomer include acrylamide, methacrylamide, diethylacrylamide, N-methylol(meth)acrylamide, N,N-dimethyl(meth)acrylamide, N,N-diethyl(meth)acrylamide, N,N′-methylenebisacrylamide, N,N-dimethylaminopropylacrylamide, N,N-dimethylaminopropylmethacrylamide, and diacetone acrylamide.

Examples of the amino group-containing monomer include aminoethyl (meth) acrylate, N,N-dimethylaminoethyl (meth) acrylate, and N,N-dimethylaminopropyl (meth) acrylate.

Examples of the keto group-containing monomer include diacetone (meth)acrylamide, diacetone (meth)acrylate, vinyl methyl ketone, and vinyl acetoacetate.

Examples of the monomer having a nitrogen atom-containing ring include N-vinyl-2-pyrrolidone and N-acryloylmorpholine.

Examples of the alkoxysilyl group-containing monomer include 3-(meth)acryloxypropyltrimethoxysilane and 3-(meth)acryloxypropyltriethoxysilane.

Examples of the imide group-containing monomer include cyclohexyl maleimide, isopropyl maleimide, N-cyclohexyl maleimide, and itaconimide.

Examples of the epoxy group-containing monomer include glycidyl (meth)acrylate, methylglycidyl (meth)acrylate, and allyl glycidyl ether.

Any appropriate content may be adopted as the content of the sub-monomer to such an extent that the effects of the present invention are not impaired. The lower limit value of the content of the sub-monomer is preferably 0.5 wt % or more, more preferably 1 wt % or more in all the monomer components for forming the acrylic polymer because the effects of the present invention can be even further expressed. In addition, the upper limit value of the content of the sub-monomer is preferably 30 wt % or less, more preferably 10 wt % or less, still more preferably 8 wt % or less, particularly preferably 5 wt % or less in all the monomer components for forming the acrylic polymer because the effects of the present invention can be even further expressed.

When the carboxy group-containing monomer is adopted as the sub-monomer (including a case in which the number of kinds of the sub-monomers is only one and a case in which the number is two or more), the lower limit value of the content of the carboxy group-containing monomer is preferably 0.1 wt % or more, more preferably 0.2 wt % or more, still more preferably 0.5 wt % or more, particularly preferably 0.7 wt % or more, most preferably 1 wt % or more in all the monomer components for forming the acrylic polymer because the effects of the present invention can be even further expressed. In addition, when the carboxy group-containing monomer is adopted as the sub-monomer (including a case in which the number of kinds of the sub-monomers is only one and a case in which the number is two or more), the upper limit value of the content of the carboxy group-containing monomer is preferably 10 wt % or less, more preferably 8 wt % or less, still more preferably 6 wt % or less, particularly preferably 5 wt % or less in all the monomer components for forming the acrylic polymer because the effects of the present invention can be even further expressed.

When the hydroxy group-containing monomer is adopted as the sub-monomer (including a case in which the number of kinds of the sub-monomers is only one and a case in which the number is two or more), the lower limit value of the content of the hydroxy group-containing monomer is preferably 0.001 wt % or more, more preferably 0.01 wt % or more, still more preferably 0.02 wt % or more, particularly preferably 0.05 wt % or more, most preferably 0.1 wt % or more in all the monomer components for forming the acrylic polymer because the effects of the present invention can be even further expressed. In addition, when the hydroxy group-containing monomer is adopted as the sub-monomer (including a case in which the number of kinds of the sub-monomers is only one and a case in which the number is two or more), the upper limit value of the content of the hydroxy group-containing monomer is preferably 10 wt % or less, more preferably 7 wt % or less, still more preferably 5 wt % or less, particularly preferably 3 wt % or less in all the monomer components for forming the acrylic polymer because the effects of the present invention can be even further expressed.

All the monomer components for forming the acrylic polymer may include any appropriate other monomer except the main monomer and the sub-monomer to such an extent that the effects of the present invention are not impaired. Examples of such other monomer include: sulfonic acid group-containing monomers, such as styrenesulfonic acid, allylsulfonic acid, and 2-(meth)acrylamido-2-methylpropanesulfonic acid; phosphoric acid group-containing monomers such as 2-hydroxyethylacryloyl phosphate; cyano group-containing monomers, such as acrylonitrile and methacrylonitrile; vinyl esters, such as vinyl acetate (VAc), vinyl propionate, and vinyl laurate; aromatic vinyl compounds, such as styrene, substituted styrenes (e.g., a-methylstyrene), and vinyltoluene; aromatic ring-containing (meth)acrylates, such as aryl (meth)acrylates (e.g., phenyl (meth)acrylate), aryloxyalkyl (meth)acrylates (e.g., phenoxyethyl (meth)acrylate), and arylalkyl (meth)acrylates (e.g., benzyl (meth)acrylate); olefin-based monomers, such as ethylene, propylene, isoprene, butadiene, and isobutylene; chlorine-containing monomers, such as vinyl chloride and vinylidene chloride; vinyl ether-based monomers, such as methyl vinyl ether and ethyl vinyl ether; and macromonomers each having a radically polymerizable vinyl group at a terminal of a monomer obtained by polymerizing a vinyl group. The number of kinds of the other monomers may be only one, or two or more.

Any appropriate content may be adopted as the content of the other monomer to such an extent that the effects of the present invention are not impaired. The lower limit value of the content of the other monomer is preferably 0 wt % or more, more preferably 0.01 wt % or more, still more preferably 0.1 wt % or more in all the monomer components for forming the acrylic polymer because the effects of the present invention can be even further expressed. In addition, the upper limit value of the content of the other monomer is preferably 30 wt % or less, more preferably 10 wt % or less, still more preferably 8 wt % or less, particularly preferably 5 wt % or less in all the monomer components for forming the acrylic polymer because the effects of the present invention can be even further expressed.

The weight-average molecular weight of the acrylic polymer is preferably from 150,000 to 1,600,000, more preferably from 200,000 to 1,400,000, still more preferably from 250,000 to 1,200,000, particularly preferably from 300,000 to 1,000,000 because the effects of the present invention can be further expressed.

Any appropriate method may be adopted as a method of producing the acrylic polymer to such an extent that the effects of the present invention are not impaired. For example, various polymerization methods known as approaches to synthesizing acrylic polymers, such as a solution polymerization method, an emulsion polymerization method, a bulk polymerization method, and a suspension polymerization method, may each be appropriately adopted as such method. Typically, a solution polymerization method out of those methods may be preferably used.

A so-called active energy ray irradiation polymerization method, such as a photopolymerization method to be performed by applying light such as UV light (typically a photopolymerization method to be performed in the presence of a photopolymerization initiator), or a radiation polymerization method to be performed by applying a radiation, such as a β ray or a γ ray, may be appropriately adopted as a polymerization method.

A collective loading system including supplying all the monomer raw materials in one stroke, a continuous supplying (dropping) system, a divided supplying (dropping) system, or the like may be appropriately adopted as a method of supplying the monomers at the time of the performance of their polymerization.

Any appropriate polymerization temperature may be adopted as a polymerization temperature in accordance with, for example, the kinds of the monomers, a solvent, and a polymerization initiator to be used. The lower limit value of such polymerization temperature is preferably 20° C. or more, more preferably 40° C. or more. The upper limit value of such polymerization temperature is preferably 170° C. or less, more preferably 140° C. or less.

Any appropriate solvent may be adopted as the solvent (polymerization solvent) to be used in the solution polymerization to such an extent that the effects of the present invention are not impaired. Examples of such solvent include: aromatic compounds (typically aromatic hydrocarbons) such as toluene; acetic acid esters such as ethyl acetate; and aliphatic or alicyclic hydrocarbons, such as hexane and cyclohexane.

Any appropriate polymerization initiator may be adopted as the polymerization initiator to be used in the polymerization in accordance with the kind of the polymerization method to such an extent that the effects of the present invention are not impaired. Examples of such polymerization initiator include: azo-based polymerization initiators such as 2,2′-azobisisobutyronitrile (AIBN); persulfate salts such as potassium persulfate; peroxide-based initiators, such as benzoyl peroxide and hydrogen peroxide; substituted ethane-based initiators such as phenyl-substituted ethane; aromatic carbonyl compounds; and redox-based initiators each based on a combination of a peroxide and a reducing agent. The number of kinds of the polymerization initiators may be only one, or two or more. Any appropriate usage amount may be adopted as the usage amount of the polymerization initiator in accordance with the kind of the polymerization method to such an extent that the effects of the present invention are not impaired. The usage amount of such polymerization initiator is, for example, preferably from 0.005 wt % to 1 wt %, more preferably from 0.01 wt % to 1 wt % with respect to all the monomer components for forming the acrylic polymer.

The polymer component in the pressure-sensitive adhesive composition for forming the acrylic pressure-sensitive adhesive may contain any appropriate other polymer except the acrylic polymer serving as the base polymer to such an extent that the effects of the present invention are not impaired.

### (1-2-1-2. Tackifying Resin)

The pressure-sensitive adhesive composition for forming the acrylic pressure-sensitive adhesive may contain a tackifying resin. The number of kinds of the tackifying resins may be only one, or two or more.

Any appropriate tackifying resin may be adopted as the tackifying resin to such an extent that the effects of the present invention are not impaired. Examples of such tackifying resin include a phenol-based tackifying resin, a terpene-based tackifying resin, a modified terpene-based tackifying resin, a rosin-based tackifying resin, a hydrocarbon-based tackifying resin, an epoxy-based tackifying resin, a polyamide-based tackifying resin, an elastomer-based tackifying resin, and a ketone-based tackifying resin.

Examples of the phenol-based tackifying resin include a terpene-phenol resin, a hydrogenated terpene-phenol resin, an alkyl phenol resin, and a rosin-phenol resin. The terpene-phenol resin refers to a polymer including a terpene residue and a phenol residue, and is a concept including both of a copolymer of a terpene and a phenol compound (terpene-phenol copolymer resin) and a phenol-modified product of a homopolymer or a copolymer of a terpene (phenol-modified terpene resin). Examples of the terpene for forming such terpene-phenol resin include monoterpenes, such as α-pinene, β-pinene, and limonene (including a d-form, an l-form, and a d/l-form (dipentene)). The hydrogenated terpene-phenol resin refers to a hydrogenated terpene-phenol resin having a structure obtained by hydrogenation of such terpene-phenol resin, and is sometimes referred to as hydrogenated terpene-phenol resin. The alkyl phenol resin is a resin (oil-based phenol resin) obtained from an alkyl phenol and formaldehyde. Examples of the alkyl phenol resin include novolac-type and resol-type resins. Examples of the rosin-phenol resin include phenol-modified products of rosins or various rosin derivatives (including rosin esters, unsaturated fatty acid-modified rosins, and unsaturated fatty acid-modified rosin esters). The rosin-phenol resin is, for example, a rosin-phenol resin obtained by a method involving adding phenol to the rosins or the various rosin derivatives with an acid catalyst, and thermally polymerizing the resultant.

Examples of the terpene-based tackifying resin include polymers of terpenes, such as α-pinene, β-pinene, d-limonene, l-limonene, and dipentene (typically monoterpenes). A homopolymer of one kind of terpene is, for example, an α-pinene polymer, a β-pinene polymer, or a dipentene polymer.

Examples of the modified terpene resin include a styrene-modified terpene resin and a hydrogenated terpene resin.

The concept of the rosin-based tackifying resin includes both of the rosins and rosin derivative resins. Examples of the rosins include: unmodified rosins (raw rosins), such as gum rosin, wood rosin, and tall oil rosin; and modified rosins obtained by modifying these unmodified rosins through hydrogenation, disproportionation, polymerization, or the like (e.g., a hydrogenated rosin, a disproportionated rosin, a polymerized rosin, and any other chemically modified rosin).

Examples of the rosin derivative resins include: rosin esters, such as unmodified rosin esters that are esters of the unmodified rosins and alcohols, and modified rosin esters that are esters of the modified rosins and alcohols; unsaturated fatty acid-modified rosins obtained by modifying the rosins with unsaturated fatty acids; unsaturated fatty acid-modified rosin esters obtained by modifying the rosin esters with unsaturated fatty acids; rosin alcohols obtained by subjecting carboxy groups of the rosins or the rosin derivative resins (e.g., the rosin esters, the unsaturated fatty acid-modified rosins, and the unsaturated fatty acid-modified rosin esters) to reduction treatments; and metal salts thereof. Examples of the rosin esters include methyl esters, triethylene glycol esters, glycerin esters, and pentaerythritol esters of unmodified rosins or modified rosins (e.g., a hydrogenated rosin, a disproportionated rosin, and a polymerized rosin).

Examples of the hydrocarbon-based tackifying resin include an aliphatic hydrocarbon resin, an aromatic hydrocarbon resin, an aliphatic cyclic hydrocarbon resin, an aliphatic-aromatic petroleum resin (e.g., a styrene-olefin-based copolymer), an aliphatic-alicyclic petroleum resin, a hydrogenated hydrocarbon resin, a coumarone-based resin, and a coumarone-indene-based resin.

The content of the tackifying resin in the pressure-sensitive adhesive composition for forming the acrylic pressure-sensitive adhesive is preferably from 1 part by weight to 80 parts by weight, more preferably from 5 parts by weight to 70 parts by weight, still more preferably from 10 parts by weight to 55 parts by weight, particularly preferably from 15 parts by weight to 50 parts by weight with respect to 100 parts by weight of the polymer component.

### (1-2-1-3. Cross-Linking Agent)

The pressure-sensitive adhesive composition for forming the acrylic pressure-sensitive adhesive may contain a cross-linking agent. The number of kinds of the cross-linking agents may be only one, or two or more.

Any appropriate cross-linking agent may be adopted as the cross-linking agent to such an extent that the effects of the present invention are not impaired. Examples of such cross-linking agent include an isocyanate-based cross-linking agent and a non-isocyanate-based cross-linking agent.

Any appropriate isocyanate-based cross-linking agent may be adopted as the isocyanate-based cross-linking agent to such an extent that the effects of the present invention are not impaired. Examples of such isocyanate-based cross-linking agent include an aromatic diisocyanate, an aliphatic diisocyanate, an alicyclic diisocyanate, and dimers and trimers of those diisocyanates. Specific examples thereof include tolylene diisocyanate, diphenylmethane diisocyanate, hexamethylene diisocyanate, xylylene diisocyanate, hydrogenated xylylene diisocyanate, isophorone diisocyanate, hydrogenated diphenylmethane diisocyanate, 1,5-naphthylene diisocyanate, 1,3-phenylene diisocyanate, 1,4-phenylene diisocyanate, butane-1,4-diisocyanate, 2,2,4-trimethylhexamethylene diisocyanate, 2,4,4-trimethylhexamethylene diisocyanate, cyclohexane-1,4-diisocyanate, dicyclohexylmethane-4,4-diisocyanate, 1,3-bis(isocyanatomethyl)cyclohexane, methylcyclohexane diisocyanate, m-tetramethylxylylene diisocyanate, and dimers and trimers thereof, and polyphenylmethane polyisocyanate. In addition, the trimer may be of, for example, an isocyanurate type, a biuret type, or an allophanate type.

A commercial product may be used as the isocyanate-based cross-linking agent. Examples of a commercial product of the polyisocyanate include a product available under the product name “TAKENATE 600” from Mitsui Chemicals, Inc., a product available under the product name “DURANATE TPA100” from Asahi Kasei Chemicals Corporation, and products available under the product names “CORONATE L”, “CORONATE HL”, “CORONATE HK”, “CORONATE HX”, and “CORONATE 2096” from Nippon Polyurethane Industry Co., Ltd.

Examples of the non-isocyanate-based cross-linking agent include an epoxy-based cross-linking agent, an oxazoline-based cross-linking agent, an aziridine-based cross-linking agent, a melamine-based cross-linking agent, a carbodiimide-based cross-linking agent, a hydrazine-based cross-linking agent, an amine-based cross-linking agent, a peroxide-based cross-linking agent, a metal chelate-based cross-linking agent, a metal alkoxide-based cross-linking agent, a metal salt-based cross-linking agent, and a silane coupling agent.

In one preferred embodiment, the epoxy-based cross-linking agent may be adopted as the non-isocyanate-based cross-linking agent. The epoxy-based cross-linking agent is preferably, for example, a compound having 2 or more epoxy groups in a molecule thereof, and is more preferably, for example, an epoxy-based cross-linking agent having 3 to 5 epoxy groups in a molecule thereof.

Specific examples of the epoxy-based cross-linking agent include N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Examples of a commercial product of the epoxy-based cross-linking agent include products available under the product names “TETRAD-C” and “TETRAD-X” from Mitsubishi Gas Chemical Company, a product available under the product name “EPICLON CR-5L” from DIC Corporation, a product available under the product name “DENACOL EX-512” from Nagase ChemteX Corporation, and a product available under the product name “TEPIC-G” from Nissan Chemical Industries, Ltd.

The content of the cross-linking agent in the pressure-sensitive adhesive composition for forming the acrylic pressure-sensitive adhesive is preferably from 0.01 part by weight to 10 parts by weight, more preferably from 0.1 part by weight to 8 parts by weight, still more preferably from 0.5 part by weight to 7 parts by weight, particularly preferably from 1.5 parts by weight to 3.5 parts by weight with respect to 100 parts by weight of the polymer component.

The isocyanate-based cross-linking agent and the non-isocyanate-based cross-linking agent (e.g., an epoxy-based cross-linking agent) may be used in combination in the pressure-sensitive adhesive composition for forming the acrylic pressure-sensitive adhesive. The ratio of the content of the non-isocyanate-based cross-linking agent in the pressure-sensitive adhesive composition for forming the acrylic pressure-sensitive adhesive to the content of the isocyanate-based cross-linking agent in the pressure-sensitive adhesive composition for forming the acrylic pressure-sensitive adhesive is preferably 1/50 or less, more preferably 1/75 or less, still more preferably 1/100 or less, particularly preferably 1/150 or less. In addition, the ratio of the content of the non-isocyanate-based cross-linking agent in the pressure-sensitive adhesive composition for forming the acrylic pressure-sensitive adhesive to the content of the isocyanate-based cross-linking agent in the pressure-sensitive adhesive composition for forming the acrylic pressure-sensitive adhesive is preferably 1/1,000 or more, more preferably 1/500 or more.

### (1-2-1-4. Filler)

The acrylic pressure-sensitive adhesive preferably contains a filler. That is, the pressure-sensitive adhesive composition for forming the acrylic pressure-sensitive adhesive preferably contains the filler. The number of kinds of the fillers may be only one, or two or more.

The incorporation of the filler into the acrylic pressure-sensitive adhesive can contribute to a reduction in tensile peeling stress at the time of the elongation and deformation of the double-sided pressure-sensitive adhesive tape. Thus, both of a satisfactory pressure-sensitive adhesive property at the time of the use of the double-sided pressure-sensitive adhesive tape and excellent tensile removability at the time of the removal thereof can be achieved. Specifically, the filler in the acrylic pressure-sensitive adhesive may be present under the state of being exposed to the surface of the pressure-sensitive adhesive layer (B) or under the state of being included in the pressure-sensitive adhesive layer (B). The filler exposed to the surface of the pressure-sensitive adhesive layer (B) can reduce the area of the acrylic pressure-sensitive adhesive on the surface of the pressure-sensitive adhesive layer (B) to improve the slipperiness of the pressure-sensitive adhesive interface of the layer in a shear direction. Thus, the tensile peeling stress can be reduced. However, the reduction in area of the acrylic pressure-sensitive adhesive on the surface of the pressure-sensitive adhesive layer (B) may cause a reduction in initial pressure-sensitive adhesive strength of the pressure-sensitive adhesive layer (B). Meanwhile, the filler present in the pressure-sensitive adhesive layer (B) may largely contribute to the reduction in tensile peeling stress without reducing the initial pressure-sensitive adhesive strength. A possible main reason for the foregoing is, for example, a change in state of the pressure-sensitive adhesive layer (B) along with the deformation of the double-sided pressure-sensitive adhesive tape. Specifically, tensile peeling is a mode in which the pressure-sensitive adhesive layer (B) is peeled in a direction parallel to its pressure-sensitive adhesive surface (a tensile peeling direction or the shear direction), and hence the double-sided pressure-sensitive adhesive tape is deformed in the direction parallel to the pressure-sensitive adhesive surface at the time of the tensile peeling. The extensible double-sided pressure-sensitive adhesive tape is elongated in response to the above-mentioned pulling, and the pressure-sensitive adhesive layer (B) is deformed along with the elongation. For example, when the base material layer (A) for supporting the pressure-sensitive adhesive layer (B) has an elongation property against pulling, the pressure-sensitive adhesive layer (B) is largely deformed along with the elongation of the base material layer (A). The deformation of the pressure-sensitive adhesive layer (B) may increase the amount of the filler in the pressure-sensitive adhesive layer (B) to be exposed to the surface of the pressure-sensitive adhesive layer (B) to improve the slipperiness at the pressure-sensitive adhesive interface in the shear direction. In addition, the following fact is taken into consideration: while the acrylic pressure-sensitive adhesive is deformed by the tensile peeling in the pressure-sensitive adhesive layer (B), the filler shows behavior different from that of the acrylic pressure-sensitive adhesive in the pressure-sensitive adhesive layer (B). The difference in behavior against the tensile peeling between the acrylic pressure-sensitive adhesive and the filler may also contribute to the reduction in tensile peeling stress. In addition, a change in surface state of the pressure-sensitive adhesive layer and the behavior of a constituent component for the pressure-sensitive adhesive layer may not become apparent or may be ignorable in, for example, 90° peeling or 180° peeling because of the difference in peeling mode. However, the change and the behavior may typically affect the stress change to a large extent at the time of the tensile peeling. Probably as a result of the foregoing, the filler in the pressure-sensitive adhesive layer (B) largely contributes to the achievement of both of the maintenance of the initial pressure-sensitive adhesive strength and the reduction in tensile peeling stress.

Any appropriate shape may be adopted as the shape of the filler to such an extent that the effects of the present invention are not impaired. Typical examples of the shape of the filler include a particle shape and a fiber shape. Of those, a particle shape is preferred.

Any appropriate filler may be adopted as the filler to such an extent that the effects of the present invention are not impaired. Examples of such filler include: metals, such as copper, silver, gold, platinum, nickel, aluminum, chromium, iron, and stainless steel; metal oxides, such as aluminum oxide, silicon oxide (silicon dioxide), titanium oxide, zirconium oxide, zinc oxide, tin oxide, copper oxide, and nickel oxide; metal hydroxides and hydrated metal compounds, such as aluminum hydroxide, boehmite, magnesium hydroxide, calcium hydroxide, zinc hydroxide, silicic acid, iron hydroxide, copper hydroxide, barium hydroxide, zirconium oxide hydrate, tin oxide hydrate, basic magnesium carbonate, hydrotalcite, dawsonite, borax, and zinc borate; carbides, such as silicon carbide, boron carbide, nitrogen carbide, and calcium carbide; nitrides, such as aluminum nitride, silicon nitride, boron nitride, and gallium nitride; carbonate salts such as calcium carbonate; titanate salts, such as barium titanate and potassium titanate; carbon-based substances, such as carbon black, a carbon tube (carbon nanotube), a carbon fiber, and diamond; inorganic materials such as glass; polymers, such as polystyrene, an acrylic resin (e.g., polymethyl methacrylate), a phenol resin, a benzoguanamine resin, a urea resin, a silicone resin, polyester, polyurethane, polyethylene (PE), polypropylene (PP), polyamide (e.g., nylon), polyimide, and polyvinylidene chloride; natural raw material particles, such as volcanic Shirasu, clay, and sand; synthetic fiber materials; and natural fiber materials because the effects of the present invention can be further expressed.

The average particle diameter of the filler is preferably less than 50% of the thickness of the pressure-sensitive adhesive layer (B). The term “average particle diameter of the filler” as used herein refers to the particle diameter (50% median diameter) at which a cumulative particle size on a weight basis becomes 50% in a particle size distribution obtained by measurement based on a sieving method. When the average particle diameter of the filler is less than 50% of the thickness of the pressure-sensitive adhesive layer (B), it can be said that 50 wt % or more of filler particles in the pressure-sensitive adhesive layer (B) have particle diameters smaller than the thickness of the pressure-sensitive adhesive layer (B). When 50 wt % or more of the filler particles in the pressure-sensitive adhesive layer (B) have particle diameters smaller than the thickness of the pressure-sensitive adhesive layer (B), a tendency in which a satisfactory surface state (e.g., smoothness) is maintained on the surface of the pressure-sensitive adhesive layer (B) becomes larger. The foregoing is preferred from the viewpoint of an improvement in pressure-sensitive adhesive property of the layer by an improvement in adhesiveness thereof with an adherend.

The average particle diameter of the filler is preferably 45% or less, more preferably 40% or less with respect to the thickness of the pressure-sensitive adhesive layer (B) because the effects of the present invention can be further expressed. The average particle diameter of the filler is preferably more than 3%, more preferably 4% or more, still more preferably 10% or more, still more preferably 15% or more, particularly preferably 20% or more, most preferably 30% or more with respect to the thickness of the pressure-sensitive adhesive layer (B) because the effects of the present invention can be further expressed.

Preferably 60 wt % or more, more preferably 70 wt % or more, still more preferably 80 wt % or more of the filler particles in the pressure-sensitive adhesive layer (B) have particle diameters smaller than the thickness T of the pressure-sensitive adhesive layer (B) because the effects of the present invention can be further expressed. In addition, substantially the total amount (e.g., 99 wt % or more and 100 wt % or less) of the filler particles in the pressure-sensitive adhesive layer (B) preferably have particle diameters smaller than the thickness T of the pressure-sensitive adhesive layer (B).

Preferably 40 wt % or more, more preferably 50 wt % or more, still more preferably 55 wt % or more of the filler particles in the pressure-sensitive adhesive layer (B) have particle diameters smaller than 2/3 of the thickness T of the pressure-sensitive adhesive layer (B) because the effects of the present invention can be further expressed. In addition, preferably 40 wt % or more, more preferably 50 wt % or more, still more preferably 55 wt % or more of the filler particles in the pressure-sensitive adhesive layer (B) have particle diameters smaller than ½ of the thickness T of the pressure-sensitive adhesive layer (B).

The phrase “X wt % or more of the filler particles have particle diameters smaller than Y” means that a cumulative particle size (weight basis) up to the particle diameter Y (μm) is less than X (wt %) in the particle size distribution obtained by the measurement based on the sieving method. The ratio (wt %) of the filler particles each having a predetermined particle diameter may be determined on the basis of the particle size distribution.

Particles each having a particle diameter of less than 30 μm account for preferably 50 wt % or more, more preferably 70 wt % or more, still more preferably 90 wt % or more of the filler in the pressure-sensitive adhesive layer (B). In the pressure-sensitive adhesive layer (B) containing such filler, even when the thickness of the pressure-sensitive adhesive layer (B) is relatively small, the smoothness of the surface of the pressure-sensitive adhesive layer is hardly impaired. Accordingly, even when the pressure-sensitive adhesive layer (B) is made thinner, both of an excellent pressure-sensitive adhesive property and excellent tensile removability at the time of the removal of the double-sided pressure-sensitive adhesive tape can be preferably achieved. The foregoing is advantageous from the viewpoint of a reduction in total thickness of the double-sided pressure-sensitive adhesive tape.

Particles each having a particle diameter of preferably less than 20 μm, more preferably less than 15 μm, still more preferably less than 10 μm account for preferably 50 wt % or more, more preferably 70 wt % or more, still more preferably 80 wt % or more of the filler in the pressure-sensitive adhesive layer (B).

The ratio of the filler particles each having a particle diameter of less than 1 μm in the filler in the pressure-sensitive adhesive layer (B) is preferably 50 wt % or less. The particle diameters of the filler particles each desirably have some degree of size from the viewpoint of a reduction in tensile peeling stress. In addition, the fact that the amount of the fine particles is limited is preferred in terms of productivity, for example, because no excessive increase in viscosity occurs in the preparation of the pressure-sensitive adhesive composition.

The ratio of the filler particles each having a particle diameter of preferably less than 1 μm, more preferably less than 2 μm, still more preferably less than 5 μm in the filler in the pressure-sensitive adhesive layer (B) is preferably 30 wt % or less, more preferably 10 wt % or less, still more preferably 5 wt % or less.

The lower limit value of the average particle diameter of the entirety of the filler in the pressure-sensitive adhesive layer (B) is preferably 0.5 μm or more, more preferably 0.8 μm or more, still more preferably 1 μm or more, still more preferably more than 1 μm, still more preferably 2 μm or more, particularly preferably 3 μm or more, most preferably 5 μm or more because the effects of the present invention can be further expressed.

The upper limit value of the average particle diameter of the entirety of the filler in the pressure-sensitive adhesive layer (B) is preferably 50 μm or less, more preferably 30 μm or less, still more preferably 20 μm or less, still more preferably 18 μm or less, still more preferably 15 μm or less, particularly preferably 12 μm or less, most preferably 10 μm or less because the effects of the present invention can be further expressed.

The average aspect ratio of the filler is preferably less than 100, more preferably less than 50, still more preferably less than 10, particularly preferably less than 5, most preferably less than 2 because the effects of the present invention can be further expressed. Herein, the average aspect ratio of the filler is determined as the average of the aspect ratios of the respective particles each represented by the expression “long diameter/short diameter” in the filler. The term “long diameter” typically refers to the maximum diameter length of a measurement object particle, and the term “short diameter” typically refers to the minimum diameter length of the measurement object particle. The average aspect ratio may be grasped through the observation of the filler with a transmission electron microscope.

In the pressure-sensitive adhesive layer (B) containing the filler, the content of the filler is preferably from 0.5 part by weight to 100 parts by weight, more preferably from 1 part by weight to 80 parts by weight, still more preferably from 3 parts by weight to 70 parts by weight, still more preferably from 5 parts by weight to 60 parts by weight, still more preferably from 10 parts by weight to 55 parts by weight, still more preferably from 15 parts by weight to 50 parts by weight, still more preferably from 20 parts by weight to 45 parts by weight, particularly preferably from 25 parts by weight to 40 parts by weight, most preferably from 30 parts by weight to 40 parts by weight with respect to 100 parts by weight of the base polymer in the pressure-sensitive adhesive layer (B) because the effects of the present invention can be further expressed.

### (1-2-1-5. Other Additive)

The pressure-sensitive adhesive composition for forming the acrylic pressure-sensitive adhesive may contain any appropriate other additive to such an extent that the effects of the present invention are not impaired. Examples of such other additive include a leveling agent, a cross-linking aid, a plasticizer, a softening agent, a colorant (a dye or a pigment), an antistatic agent, an age resistor, a UV absorber, an antioxidant, a light stabilizer, a dispersant, and an oligomer.

### (1-2-1-6. Formation of Acrylic Pressure-Sensitive Adhesive)

The acrylic pressure-sensitive adhesive may be formed from the pressure-sensitive adhesive composition by any appropriate method to such an extent that the effects of the present invention are not impaired. Examples of such method include: a method (direct method) including applying the pressure-sensitive adhesive composition onto any appropriate base material (e.g., the base material layer (A)), and drying the composition as required, to form the pressure-sensitive adhesive layer on the base material; and a method (transfer method) including applying the pressure-sensitive adhesive composition to a surface having releasability (release surface), and drying the composition as required, to form the pressure-sensitive adhesive layer on the surface having releasability (release surface), and transferring the pressure-sensitive adhesive layer onto any appropriate base material (e.g., the base material layer (A)). The surface having releasability (release surface) is, for example, the surface of the above-mentioned release liner.

Any appropriate application method may be adopted as a method of applying the pressure-sensitive adhesive composition to such an extent that the effects of the present invention are not impaired. Examples of such application method include roll coating, gravure coating, reverse coating, roll brushing, spray coating, an air knife coating method, and extrusion coating with a die coater. Active energy ray irradiation such as UV irradiation may be performed for curing an applied layer formed by the application.

The drying of the pressure-sensitive adhesive composition may be performed under heating from the viewpoints of, for example, the acceleration of the cross-linking reaction of the composition and an improvement in production efficiency of the double-sided pressure-sensitive adhesive tape. A drying temperature may be typically set to, for example, from 40° C. to 150° C., and is preferably from 60° C. to 130° C. After the drying of the pressure-sensitive adhesive composition, aging may be further performed for the purposes of, for example, adjusting the migration of a component in the pressure-sensitive adhesive layer (B), advancing the cross-linking reaction, and alleviating strain that may be present in the pressure-sensitive adhesive layer (B).

### <1-2-2. Rubber-Based Pressure-Sensitive Adhesive>

One embodiment of the pressure-sensitive adhesive layer (B) is a rubber-based pressure-sensitive adhesive containing a rubber-based polymer as the main component (base polymer) of its polymer component. That is, the main component (base polymer) of the polymer component in a pressure-sensitive adhesive composition for forming the rubber-based pressure-sensitive adhesive is the rubber-based polymer.

The content of the polymer component (containing the rubber-based polymer as its base polymer) in the pressure-sensitive adhesive composition for forming the rubber-based pressure-sensitive adhesive is preferably from 20 wt % to 95 wt %, more preferably from 30 wt % to 85 wt %, still more preferably from 40 wt % to 75 wt %, particularly preferably from 50 wt % to 65 wt % with respect to 100 wt % of the pressure-sensitive adhesive composition.

### (1-2-2-1. Polymer Component)

The content of the rubber-based polymer serving as the base polymer in the polymer component in the pressure-sensitive adhesive composition for forming the rubber-based pressure-sensitive adhesive is preferably from 50 wt % to 100 wt %, more preferably from 70 wt % to 100 wt %, still more preferably from 80 wt % to 100 wt %, particularly preferably from 90 wt % to 100 wt % with respect to 100 wt % of the polymer component.

The rubber-based polymer may be typically at least one kind selected from the group consisting of: a natural rubber; and a synthetic rubber.

Specific examples of the synthetic rubber include polyisoprene, polybutadiene, polyisobutylene, a butyl rubber, an ethylene-propylene rubber, a propylene-butene rubber, an ethylene-propylene-butene rubber, a styrene-butadiene rubber (SBR), a styrene-based block copolymer, a hydrogenated product of a styrene-based block copolymer, and a graft-modified natural rubber obtained by grafting a natural rubber with another monomer.

Examples of the styrene-based block copolymer include: styrene-based ABA-type block copolymers (triblock copolymers), such as a styrene-butadiene-styrene copolymer (SBS) and a styrene-isoprene-styrene copolymer (SIS); styrene-based ABAB-type block copolymers (tetrablock copolymers), such as a styrene-butadiene-styrene-butadiene copolymer (SBSB) and a styrene-isoprene-styrene-isoprene copolymer (SISI); styrene-based ABABA-type block copolymers (pentablock copolymers), such as a styrene-butadiene-styrene-butadiene-styrene copolymer (SBSBS) and a styrene-isoprene-styrene-isoprene-styrene copolymer (SISIS); and styrene-based block copolymers each having a larger number of AB repeating units.

Examples of the hydrogenated product of the styrene-based block copolymer include a styrene-ethylene-butylene copolymer-styrene copolymer (SEBS), a styrene-ethylene-propylene copolymer-styrene copolymer (SEPS), and a copolymer of a styrene-ethylene-butylene copolymer and a styrene-ethylene-butylene copolymer (SEBSEB).

The rubber-based pressure-sensitive adhesive that is one embodiment of the pressure-sensitive adhesive layer (B) preferably contains the styrene-based block copolymer as a base polymer. The base polymer typically contains at least one kind selected from the group consisting of: a styrene-butadiene-styrene copolymer (SBS); a styrene-isoprene-styrene copolymer (SIS); and a styrene-ethylene-butylene copolymer-styrene copolymer (SEBS).

When the base polymer contains at least one kind selected from the group consisting of: a styrene-butadiene-styrene copolymer (SBS); a styrene-isoprene-styrene copolymer (SIS); and a styrene-ethylene-butylene copolymer-styrene copolymer (SEBS), the total content of the styrene-butadiene-styrene copolymer (SBS), the styrene-isoprene-styrene copolymer (SIS), and the styrene-ethylene-butylene copolymer-styrene copolymer (SEBS) in the base polymer is preferably from 70 wt % to 100 wt %, more preferably from 80 wt % to 100 wt %, still more preferably from 90 wt % to 100 wt %, particularly preferably from 95 wt % to 100 wt %, most preferably substantially 100 wt %.

The styrene content of the styrene-based block copolymer may be, for example, 5 wt % or more and 40 wt % or less. Typically, a styrene-based block copolymer having a styrene content of 10 wt % or more (more preferably more than 10 wt %, for example, 12 wt % or more) is preferred from the viewpoint of tensile peelability. In addition, a styrene-based block copolymer having a styrene content of 35 wt % or less (typically 30 wt % or less, more preferably 25 wt % or less, for example, less than 20 wt %) is preferred from the viewpoints of a pressure-sensitive adhesive strength to an adherend and impact resistance. For example, a styrene-based block copolymer having a styrene content of 12 wt % or more and less than 20 wt % may be preferably adopted.

The polymer component in the pressure-sensitive adhesive composition for forming the rubber-based pressure-sensitive adhesive may contain any appropriate other polymer except the rubber-based polymer serving as the base polymer to such an extent that the effects of the present invention are not impaired.

### (1-2-2-2. Tackifying Resin)

The pressure-sensitive adhesive composition for forming the rubber-based pressure-sensitive adhesive may contain a tackifying resin. The number of kinds of the tackifying resins may be only one, or two or more.

The tackifying resin described in the section (1-2-1-2. Tackifying Resin) may be incorporated as the tackifying resin that may be incorporated into the pressure-sensitive adhesive composition for forming the rubber-based pressure-sensitive adhesive.

The content of the tackifying resin in the pressure-sensitive adhesive composition for forming the rubber-based pressure-sensitive adhesive is preferably from 20 parts by weight to 120 parts by weight, more preferably from 30 parts by weight to 110 parts by weight, still more preferably from 40 parts by weight to 100 parts by weight, particularly preferably from 50 parts by weight to 90 parts by weight with respect to 100 parts by weight of the polymer component.

### (1-2-2-3. Cross-Linking Agent)

The pressure-sensitive adhesive composition for forming the rubber-based pressure-sensitive adhesive may contain a cross-linking agent. The number of kinds of the cross-linking agents may be only one, or two or more.

The cross-linking agent described in the section (1-2-1-3. Cross-linking Agent) may be incorporated as the cross-linking agent that may be incorporated into the pressure-sensitive adhesive composition for forming the rubber-based pressure-sensitive adhesive.

The content of the cross-linking agent in the pressure-sensitive adhesive composition for forming the rubber-based pressure-sensitive adhesive is preferably from 0.01 part by weight to 5 parts by weight, more preferably from 0.05 part by weight to 3 parts by weight, still more preferably from 0.1 part by weight to 2 parts by weight, particularly preferably from 0.2 part by weight to 1 part by weight with respect to 100 parts by weight of the polymer component.

The isocyanate-based cross-linking agent and the non-isocyanate-based cross-linking agent (e.g., an epoxy-based cross-linking agent) may be used in combination in the pressure-sensitive adhesive composition for forming the rubber-based pressure-sensitive adhesive. The ratio of the content of the non-isocyanate-based cross-linking agent in the pressure-sensitive adhesive composition for forming the rubber-based pressure-sensitive adhesive to the content of the isocyanate-based cross-linking agent in the pressure-sensitive adhesive composition for forming the rubber-based pressure-sensitive adhesive is preferably 1/50 or less, more preferably 1/75 or less, still more preferably 1/100 or less, particularly preferably 1/150 or less. In addition, the ratio of the content of the non-isocyanate-based cross-linking agent in the pressure-sensitive adhesive composition for forming the rubber-based pressure-sensitive adhesive to the content of the isocyanate-based cross-linking agent in the pressure-sensitive adhesive composition for forming the rubber-based pressure-sensitive adhesive is preferably 1/1,000 or more, more preferably 1/500 or more.

### (1-2-2-4. Other Additive)

The pressure-sensitive adhesive composition for forming the rubber-based pressure-sensitive adhesive may contain any appropriate other additive to such an extent that the effects of the present invention are not impaired. Examples of such other additive include a leveling agent, a cross-linking aid, a plasticizer, a softening agent, a colorant (a dye or a pigment), an antistatic agent, an age resistor, a UV absorber, an antioxidant, a light stabilizer, a dispersant, and an oligomer.

### (1-2-2-5. Formation of Rubber-Based Pressure-Sensitive Adhesive)

The rubber-based pressure-sensitive adhesive may be formed from the pressure-sensitive adhesive composition by any appropriate method to such an extent that the effects of the present invention are not impaired. Examples of such method include: a method (direct method) including applying the pressure-sensitive adhesive composition onto any appropriate base material (e.g., the base material layer (A)), and drying the composition as required, to form the pressure-sensitive adhesive layer on the base material; and a method (transfer method) including applying the pressure-sensitive adhesive composition to a surface having releasability (release surface), and drying the composition as required, to form the pressure-sensitive adhesive layer on the surface having releasability (release surface), and transferring the pressure-sensitive adhesive layer onto any appropriate base material (e.g., the base material layer (A)). The surface having releasability (release surface) is, for example, the surface of the above-mentioned release liner.

Any appropriate application method may be adopted as a method of applying the pressure-sensitive adhesive composition to such an extent that the effects of the present invention are not impaired. Examples of such application method include roll coating, gravure coating, reverse coating, roll brushing, spray coating, an air knife coating method, and extrusion coating with a die coater. Active energy ray irradiation such as UV irradiation may be performed for curing an applied layer formed by the application.

The drying of the pressure-sensitive adhesive composition may be performed under heating from the viewpoints of, for example, the acceleration of the cross-linking reaction of the composition and an improvement in production efficiency of the double-sided pressure-sensitive adhesive tape. A drying temperature may be typically set to, for example, from 40° C. to 150° C., and is preferably from 60° C. to 130° C. After the drying of the pressure-sensitive adhesive composition, aging may be further performed for the purposes of, for example, adjusting the migration of a component in the pressure-sensitive adhesive layer (B), advancing the cross-linking reaction, and alleviating strain that may be present in the pressure-sensitive adhesive layer (B).

### EXAMPLES

Now, the present invention is specifically described by way of Examples. However, the present invention is by no means limited to these Examples. Test and evaluation methods in Examples and the like are as described below. The term “part(s)” in the following description means “part(s) by weight” unless otherwise specified, and the term “%” in the following description means “wt %” unless otherwise specified.

### <Initial Pressure-Sensitive Adhesive Strength>

An initial pressure-sensitive adhesive strength was measured by the following method. A double-sided pressure-sensitive adhesive tape cut into a size measuring 10 mm wide by 100 mm long was prepared. The pressure-sensitive adhesive layer surfaces of the prepared double-sided pressure-sensitive adhesive tape were exposed under an environment at 23° C. and 50% RH, and a polyethylene terephthalate (PET) film having a thickness of 25 μm was bonded to one of the surfaces. After that, the other pressure-sensitive adhesive layer surface was pressure-bonded to the surface of each of a SUS304BA plate, a polypropylene plate, a polycarbonate plate, and a copper plate by one pass back and forth with a 2 kg roller. The resultant laminate was left to stand under the environment at 23° C. and 50% RH for 30 minutes, and then its peel strength (N/10 mm) was measured with a tensile tester in conformity with JIS-Z-0237-2000 under the conditions of a tensile rate of 300 mm/min and a peel angle of 180°. A universal tensile compression tester (product name: “TG-1 kN”, manufactured by Minebea Co., Ltd.) was used as the tensile tester.

### <Tensile Test>

Measurement was performed in conformity with a method of measuring an “elongation” described in JIS-K-7311-1995. More specifically, the elongation at break of a test piece of a No. 1 dumbbell shape (having a width of 10 mm and a gauge interval of 10 mm) was measured under the condition of a tensile rate of 300 mm/min. A tester available under the product name “Autograph AG-10G Type Tensile Tester” from Shimadzu Corporation was used as a tensile tester. At the time of the test, powder (Johnson & Johnson K.K., BABY POWDER (main component: talc)) was sprinkled on each of the pressure-sensitive adhesive layer surfaces of the test piece to remove an influence caused by the stickiness of the pressure-sensitive adhesive of the surface. A tensile direction in the tensile test was caused to coincide with the lengthwise direction of the double-sided pressure-sensitive adhesive tape. The tensile strength (N/10 mm) of the test piece at an elongation of 600% was also measured by the test.

### <Reworking Property Test>

A reworking property test was performed by the following method. A double-sided pressure-sensitive adhesive tape cut into a size measuring 15 mm wide by 50 mm long was prepared. The pressure-sensitive adhesive layer surfaces of the double-sided pressure-sensitive adhesive tape were exposed under an environment at 23° C. and 50% RH, and one of the pressure-sensitive adhesive layer surfaces was pressure-bonded to the surface of a polycarbonate plate by one pass back and forth with a 2 kg roller. Further, the other pressure-sensitive adhesive layer surface was pressure-bonded to the copper foil surface side of a polycarbonate plate having laminated thereon copper foil having a thickness of 35 μm by one pass back and forth with a 2 kg roller. At this time, both the surfaces of the double-sided pressure-sensitive adhesive tape each having a length of 40 mm were sandwiched between the polycarbonate plate and the copper foil, and the portion of the double-sided pressure-sensitive adhesive tape having a length of 10 mm was brought into a state in which no layer was laminated thereon. The portion was adopted as a tab for drawing. The resultant laminate was left to stand under the environment at 23° C. and 50% RH for 30 minutes, and then the tab was drawn with a hand at an angle of 15° from a direction perpendicular to the direction in which the layers, the plate, and the foil were laminated until the pressure-sensitive adhesive layer surfaces of the double-sided pressure-sensitive adhesive tape were each peeled in its lengthwise direction by 1 cm. After that, the double-sided pressure-sensitive adhesive tape was peeled at an angle of 0°. At that time, the following three items were evaluated as reworking properties.

### (i) Peelability

Whether or not the tape was able to be peeled to the end was recognized.

∘: The tape was able to be peeled to the end.
x: The tape was heavy and hence could not be peeled to the end, or the tape broke during its peeling.

### (ii) Damage to Copper Foil

Whether or not the copper foil was folded was recognized.

∘: The copper foil was not folded.
x: The copper foil was folded and damaged.
(iii) Peeling Performed Plurality of Separate Times

Whether or not the tape was able to be peeled even when its peeling was stopped in midstream and the tape was pulled a plurality of separate times was recognized.

∘: The tape was able to be peeled.
x: The tape could not be peeled.

### [Production Example 1]: Production of Base Material (1)

Polypropylene (propylene-1-butene-α-olefin copolymer type, PP, manufactured by Mitsui Chemicals, Inc.) was used as an X layer, and an ethylene-vinyl acetate copolymer (EVA, manufactured by Tosoh Corporation) was used as a Y layer. The materials were molded with a two-kind and three-layer (X layer/Y layer/X layer) extrusion T-die molding machine. The extrusion of the layers was performed at the following temperatures.

| | |
|---|---|
| X layer: | 200° C. |
| Y layer: | 200° C. |
| X layer: | 200° C. |
| Die temperature: | 200° C. |

The materials were coextrusion-molded from the T-die to be integrated. Thus, a two-kind and three-layer type base material layer having the configuration “PP/EVA/PP” (thickness: PP/EVA/PP=25 μm/100 μm/25 μm) was obtained. The layer was sufficiently solidified, and was then wound in a roll shape to provide a base material (1) (total thickness=150 μm) serving as a roll body.

### [Production Example 2]: Production of Base Material (2)

Polypropylene (propylene-1-butene-α-olefin copolymer type, PP, manufactured by Mitsui Chemicals, Inc.) was used as an X layer, and an ethylene-vinyl acetate copolymer (EVA, manufactured by Tosoh Corporation) was used as a Y layer. The materials were molded with a two-kind and three-layer (X layer/Y layer/X layer) extrusion T-die molding machine. The extrusion of the layers was performed at the following temperatures.

| | |
|---|---|
| X layer: | 200° C. |
| Y layer: | 200° C. |
| X layer: | 200° C. |
| Die temperature: | 200° C. |

The materials were coextrusion-molded from the T-die to be integrated. Thus, a two-kind and three-layer type base material layer having the configuration “PP/EVA/PP” (thickness: PP/EVA/PP=40 μm/120 μm/40 μm) was obtained. The layer was sufficiently solidified, and was then wound in a roll shape to provide a base material (2) (total thickness=200 μm) serving as a roll body.

### [Production Example 3]: Production of Base Material (3)

Polypropylene (propylene-1-butene-α-olefin copolymer type, PP, manufactured by Mitsui Chemicals, Inc.) was used as an X layer, and an ethylene-vinyl acetate copolymer (EVA, manufactured by Tosoh Corporation) was used as a Y layer. The materials were molded with a two-kind and three-layer (X layer/Y layer/X layer) extrusion T-die molding machine. The extrusion of the layers was performed at the following temperatures.

| | |
|---|---|
| X layer: | 200° C. |
| Y layer: | 200° C. |
| X layer: | 200° C. |
| Die temperature: | 200° C. |

The materials were coextrusion-molded from the T-die to be integrated. Thus, a two-kind and three-layer type base material layer having the configuration “PP/EVA/PP” (thickness: PP/EVA/PP=50 μm/200 μm/50 μm) was obtained. The layer was sufficiently solidified, and was then wound in a roll shape to provide a base material (3) (total thickness=300 μm) serving as a roll body.

### [Production Example 4]: Production of Base Material (4)

Polyethylene (ethylene-α-olefin copolymer type, PE, manufactured by Mitsui Chemicals, Inc.) was used as an X layer, and polypropylene (propylene-1-butene-α-olefin copolymer type, PP, manufactured by Mitsui Chemicals, Inc.) was used as a Y layer. The materials were molded with a two-kind and three-layer (X layer/Y layer/X layer) extrusion T-die molding machine. The extrusion of the layers was performed at the following temperatures.

| | |
|---|---|
| X layer: | 200° C. |
| Y layer: | 200° C. |
| X layer: | 200° C. |
| Die temperature: | 200° C. |

The materials were coextrusion-molded from the T-die to be integrated. Thus, a two-kind and three-layer type base material layer having the configuration “PE/PP/PE” (thickness: PE/PP/PE=25 μm/100 μm/25 μm) was obtained. The layer was sufficiently solidified, and was then wound in a roll shape to provide a base material (4) (total thickness=150 μm) serving as a roll body.

### [Production Example 5]: Production of Base Material (5)

Thermoplastic polyurethane (TPU, product name: SILKLON NES85, manufactured by Okura Industrial Co., Ltd., thickness=100 μm) was used as a base material (5).

### [Production Example 6]: Production of Base Material (6)

Thermoplastic polyurethane (TPU, product name: ESMER URS ET-B #6, manufactured by Nihon Matai Co., Ltd., thickness=60 μm) was used as a base material (6).

### [Production Example 7]: Production of Base Material (7)

A SEBS-EVA blend sheet (ULTRATHENE 635 (manufactured by Tosoh Corporation):KRATON G1657 (manufactured by Kraton Polymers Japan Ltd.)=70:30, manufactured by Nitoms, Inc., thickness=150 μm) was used as a base material (7).

### [Production Example 8]: Production of Base Material (8)

A polyurethane sheet (product name: STK20D, manufactured by Nihon Matai Co., Ltd., thickness=190 μm) was used as a base material (8).

### [Production Example 9]: Production of Pressure-Sensitive Adhesive Layers (1) Each Including Acrylic Pressure-Sensitive Adhesive (1)

95 Parts of butyl acrylate (BA) and 5 parts of acrylic acid (AA) serving as monomer components, 0.2 part of 2,2′-azobisisobutyronitrile (AIBN) serving as a polymerization initiator, and ethyl acetate serving as a polymerization solvent were loaded into a reaction vessel including a stirring machine, a temperature gauge, a nitrogen gas-introducing tube, a reflux condenser, and a dropping funnel, and were subjected to solution polymerization at 60° C. for 6 hours to provide a solution of an acrylic polymer (AP1). The acrylic polymer (AP1) had a Mw of 60×10⁴.

30 Parts of a terpene-phenol resin (manufactured by Yasuhara Chemical Co., Ltd., product name: “YS POLYSTER S145”, softening point: 145° C.), 2 parts of an isocyanate-based cross-linking agent (manufactured by Tosoh Corporation, product name: “CORONATE L”), 0.01 part of an epoxy-based cross-linking agent (manufactured by Mitsubishi Gas Chemical Company, Inc., product name: “TETRAD-C”), and 30 parts of aluminum hydroxide particles (manufactured by Nippon Light Metal Company, Ltd., product name: “B103”) serving as filler particles per 100 parts of the acrylic polymer (AP1) in the resultant solution of the acrylic polymer (AP1) were added to the solution of the acrylic polymer (AP1), and the materials were stirred and mixed to prepare a pressure-sensitive adhesive composition. The filler particles had an average particle diameter of 8 μm, and contained particles each having a particle diameter of less than 25 μm at a ratio of 85% or more, and particles each having a particle diameter of less than 1 μm at a ratio of 3%.

Two release liners each obtained by subjecting a PET film having a thickness of 38 μm to silicone treatment were prepared. The pressure-sensitive adhesive composition was applied to one surface (release surface) of each of the release liners so that its thickness after drying became 50 μm, followed by drying at 100° C. for 2 minutes. Thus, pressure-sensitive adhesive layers (1) (a first pressure-sensitive adhesive layer and a second pressure-sensitive adhesive layer) each including an acrylic pressure-sensitive adhesive (1) were formed on the release surfaces of the two release liners.

### [Production Example 10]: Production of Pressure-Sensitive Adhesive Layers (2) Each Including Rubber-Based Pressure-Sensitive Adhesive (1)

100 Parts of a SIS block copolymer (product name: “QUINTAC 3520”, manufactured by Zeon Corporation), 20 parts of a terpene-phenol resin (manufactured by Yasuhara Chemical Co., Ltd., product name: “YS POLYSTER S145”, softening point: 145° C.), 20 parts of another terpene-phenol resin (manufactured by Yasuhara Chemical Co., Ltd., product name: “YS POLYSTER 1145”, softening point: 145° C.), 30 parts of a terpene resin (manufactured by Yasuhara Chemical Co., Ltd., product name: “YS RESIN PX1150N”, softening point: 115° C.), 0.75 part of an isocyanate-based cross-linking agent (manufactured by Tosoh Corporation, product name: “CORONATE L”), 2 parts of a stabilizer (manufactured by BASF SE, product name: “Irgafos 168”), and 1 part of an antioxidant (manufactured by BASF SE, product name: “Irganox 565”) were blended, and were dissolved in toluene to prepare a pressure-sensitive adhesive composition.

Two release liners each obtained by subjecting a PET film having a thickness of 38 μm to silicone treatment were prepared. The pressure-sensitive adhesive composition was applied to one surface (release surface) of each of the release liners so that its thickness after drying became 50 μm, followed by drying at 100° C. for 2 minutes. Thus, pressure-sensitive adhesive layers (2) (a first pressure-sensitive adhesive layer and a second pressure-sensitive adhesive layer) each including a rubber-based pressure-sensitive adhesive (1) were formed on the release surfaces of the two release liners.

### [Production Example 11]: Production of Pressure-Sensitive Adhesive Layers (3) Each Including Acrylic Pressure-Sensitive Adhesive (1)

A pressure-sensitive adhesive composition was obtained in the same manner as in Production Example 9.

Two release liners each obtained by subjecting a PET film having a thickness of 38 μm to silicone treatment were prepared. The pressure-sensitive adhesive composition was applied to one surface (release surface) of each of the release liners so that its thickness after drying became 95 μm, followed by drying at 100° C. for 2 minutes. Thus, pressure-sensitive adhesive layers (3) (a first pressure-sensitive adhesive layer and a second pressure-sensitive adhesive layer) each including an acrylic pressure-sensitive adhesive (1) were formed on the release surfaces of the two release liners.

### [Production Example 12]: Production of Pressure-Sensitive Adhesive Layers (4) Each Including Rubber-Based Pressure-Sensitive Adhesive (2)

100 Parts of a SBS block copolymer (product name: “KRATON D1101JU”, manufactured by Kraton Polymers), 3 parts of a softening agent (product name: “KOMOREX F22”, manufactured by JXTG Energy Corporation), 80 parts of a C5 petroleum-based resin (product name: “QUINTONE U185”, manufactured by Zeon Corporation), 40 parts of a terpene resin (product name: “PICCOLYTE A-115”, manufactured by Hercules Incorporated), 50 parts of a terpene-phenol resin (manufactured by Yasuhara Chemical Co., Ltd., product name: “YS POLYSTER S145”, softening point: 145° C.), 3 parts of an isocyanate-based cross-linking agent (manufactured by Tosoh Corporation, product name: “CORONATE L”), 2 parts of an age resistor (product name: “NOCRAC 200”, manufactured by Ouchi Shinko Chemical Industrial Co., Ltd.), 1 part of another age resistor (product name: “NOCRAC MB”, manufactured by Ouchi Shinko Chemical Industrial Co., Ltd.), 2 parts of a stabilizer (manufactured by BASF SE, product name: “Irgafos 168”), and 1 part of an antioxidant (manufactured by BASF SE, product name: “Irganox 565”) were blended, and were dissolved in toluene to prepare a solution of a pressure-sensitive adhesive composition.

Two release liners each obtained by subjecting a PET film having a thickness of 38 μm to silicone treatment were prepared. The pressure-sensitive adhesive composition was applied to one surface (release surface) of each of the release liners so that its thickness after drying became 50 μm, followed by drying at 100° C. for 2 minutes. Thus, pressure-sensitive adhesive layers (4) (a first pressure-sensitive adhesive layer and a second pressure-sensitive adhesive layer) each including a rubber-based pressure-sensitive adhesive (2) were formed on the release surfaces of the two release liners.

### [Production Example 13]: Production of Pressure-Sensitive Adhesive Layers (5) Each Including Rubber-Based Pressure-Sensitive Adhesive (3)

70 Parts of a SEBS block copolymer (product name: “KRATON G1657 VS”, manufactured by Kraton Polymers), 30 parts of a SIS block copolymer (product name: “QUINTAC 3520”, manufactured by Zeon Corporation), 30 parts of a softening agent (product name: “DIANA PROCESS OIL PW-90”, manufactured by Idemitsu Kosan Co., Ltd.), 160 parts of an alicyclic saturated hydrocarbon resin (product name: “ARKON P100”, manufactured by Arakawa Chemical Industries, Ltd.), 5 parts of a polyethylene bead resin (product name: “SUMIKATHENE EMB-23”, manufactured by Sumitomo Chemical Co., Ltd.), 2 parts of an age resistor (product name: “NOCRAC 200”, manufactured by Ouchi Shinko Chemical Industrial Co., Ltd.), 1 part of another age resistor (product name: “NOCRAC MB”, manufactured by Ouchi Shinko Chemical Industrial Co., Ltd.), 2 parts of a stabilizer (manufactured by BASF SE, product name: “Irgafos 168”), and 1 part of an antioxidant (manufactured by BASF SE, product name: “Irganox 565”) were kneaded with a biaxial extruder at 170° C. to prepare a pressure-sensitive adhesive composition.

Two release liners each obtained by subjecting a PET film having a thickness of 38 μm to silicone treatment were prepared. The pressure-sensitive adhesive composition was extruded with an extruder at 200° C. onto one surface (release surface) of each of the release liners so that its thickness became 50 μm. Thus, pressure-sensitive adhesive layers (5) (a first pressure-sensitive adhesive layer and a second pressure-sensitive adhesive layer) each including a rubber-based pressure-sensitive adhesive (3) were formed on the release surfaces of the two release liners.

### [Production Example 14]: Production of Pressure-Sensitive Adhesive Layers (6) Each Including Acrylic Pressure-Sensitive Adhesive (2)

Pressure-sensitive adhesive layers (6) (a first pressure-sensitive adhesive layer and a second pressure-sensitive adhesive layer) each including an acrylic pressure-sensitive adhesive (2) were formed on the release surfaces of two release liners in the same manner as in Production Example 9 except that the filler particles were not used.

### Example 1

The pressure-sensitive adhesive layers (1) formed on the release surfaces of the two release liners obtained in Production Example 9 were bonded to both the surfaces of the base material (1) obtained in Production Example 1. The release liners were left as they were on the pressure-sensitive adhesive layers (1) to be used for the protection of the surfaces of the pressure-sensitive adhesive layers (1). The resultant structural body was passed through a laminator (0.3 MPa, speed: 0.5 m/min) at 70° C. once, and was then aged in an oven at 50° C. for 2 days. Thus, a double-sided pressure-sensitive adhesive tape (1) having a total thickness of 250 μm was produced. Various results are shown in Table 1.

### Example 2

A double-sided pressure-sensitive adhesive tape (2) having a total thickness of 300 μm was produced in the same manner as in Example 1 except that the base material (2) obtained in Production Example 2 was used instead of the base material (1). Various results are shown in Table 1.

### Example 3

A double-sided pressure-sensitive adhesive tape (3) having a total thickness of 400 μm was produced in the same manner as in Example 1 except that the base material (3) obtained in Production Example 3 was used instead of the base material (1). Various results are shown in Table 1.

### Example 4

A double-sided pressure-sensitive adhesive tape (4) having a total thickness of 250 μm was produced in the same manner as in Example 1 except that the base material (4) obtained in Production Example 4 was used instead of the base material (1). Various results are shown in Table 1.

### Example 5

The pressure-sensitive adhesive layers (2) formed on the release surfaces of the two release liners obtained in Production Example 10 were bonded to both the surfaces of the base material (4) obtained in Production Example 4. The release liners were left as they were on the pressure-sensitive adhesive layers (2) to be used for the protection of the surfaces of the pressure-sensitive adhesive layers (2). The resultant structural body was passed through a laminator (0.3 MPa, speed: 0.5 m/min) at 70° C. once, and was then aged in an oven at 50° C. for 2 days. Thus, a double-sided pressure-sensitive adhesive tape (5) having a total thickness of 250 μm was produced. Various results are shown in Table 1.

### Example 6

A double-sided pressure-sensitive adhesive tape (6) having a total thickness of 200 μm was produced in the same manner as in Example 1 except that the base material (5) obtained in Production Example 5 was used instead of the base material (1). Various results are shown in Table 1.

### Example 7

A double-sided pressure-sensitive adhesive tape (7) having a total thickness of 200 μm was produced in the same manner as in Example 5 except that the base material (5) obtained in Production Example 5 was used instead of the base material (4). Various results are shown in Table 1.

### Example 8

The pressure-sensitive adhesive layers (3) formed on the release surfaces of the two release liners obtained in Production Example 11 were bonded to both the surfaces of the base material (6) obtained in Production Example 6. The release liners were left as they were on the pressure-sensitive adhesive layers (3) to be used for the protection of the surfaces of the pressure-sensitive adhesive layers (3). The resultant structural body was passed through a laminator (0.3 MPa, speed: 0.5 m/min) at 70° C. once, and was then aged in an oven at 50° C. for 2 days. Thus, a double-sided pressure-sensitive adhesive tape (8) having a total thickness of 250 μm was produced. Various results are shown in Table 1.

### Example 9

A double-sided pressure-sensitive adhesive tape (9) having a total thickness of 250 μm was produced in the same manner as in Example 5 except that the base material (7) obtained in Production Example 7 was used instead of the base material (4). Various results are shown in Table 1.

### Example 10

The pressure-sensitive adhesive layers (4) formed on the release surfaces of the two release liners obtained in Production Example 12 were bonded to both the surfaces of the base material (7) obtained in Production Example 7. The release liners were left as they were on the pressure-sensitive adhesive layers (4) to be used for the protection of the surfaces of the pressure-sensitive adhesive layers (4). The resultant structural body was passed through a laminator (0.3 MPa, speed: 0.5 m/min) at 70° C. once, and was then aged in an oven at 50° C. for 2 days. Thus, a double-sided pressure-sensitive adhesive tape (10) having a total thickness of 250 μm was produced. Various results are shown in Table 1.

### Example 11

The pressure-sensitive adhesive layers (5) formed on the release surfaces of the two release liners obtained in Production Example 13 were bonded to both the surfaces of the base material (7) obtained in Production Example 7. The release liners were left as they were on the pressure-sensitive adhesive layers (5) to be used for the protection of the surfaces of the pressure-sensitive adhesive layers (5). The resultant structural body was passed through a laminator (0.3 MPa, speed: 0.5 m/min) at 70° C. once, and was then aged in an oven at 50° C. for 2 days. Thus, a double-sided pressure-sensitive adhesive tape (11) having a total thickness of 250 μm was produced. Various results are shown in Table 1.

### Example 12

The pressure-sensitive adhesive layers (2) formed on the release surfaces of the two release liners obtained in Production Example 10 were bonded to both the surfaces of the base material (7) obtained in Production Example 7. The release liners were left as they were on the pressure-sensitive adhesive layers (2) to be used for the protection of the surfaces of the pressure-sensitive adhesive layers (2). The resultant structural body was passed through a laminator (0.3 MPa, speed: 0.5 m/min) at 70° C. once, and was then aged in an oven at 50° C. for 2 days. Thus, a double-sided pressure-sensitive adhesive tape (12) having a total thickness of 250 μm was produced. Various results are shown in Table 1.

### Comparative Example 1

A double-sided pressure-sensitive adhesive tape (C1) having a total thickness of 250 μm was produced in the same manner as in Example 1 except that the base material (8) obtained in Production Example 8 was used instead of the base material (1). Various results are shown in Table 1.

### Comparative Example 2

The pressure-sensitive adhesive layers (6) formed on the release surfaces of the two release liners obtained in Production Example 14 were bonded to both the surfaces of the base material (1) obtained in Production Example 1. The release liners were left as they were on the pressure-sensitive adhesive layers (6) to be used for the protection of the surfaces of the pressure-sensitive adhesive layers (6). The resultant structural body was passed through a laminator (0.3 MPa, speed: 0.5 m/min) at 70° C. once, and was then aged in an oven at 50° C. for 2 days. Thus, a double-sided pressure-sensitive adhesive tape (C2) having a total thickness of 250 μm was produced. Various results are shown in Table 1.

TABLE 1

| | | | | Example | Example | Example | Example | Example | Example | Example |
|---|---|---|---|---|---|---|---|---|---|---|
| | | | | 1 | 2 | 3 | 4 | 5 | 6 | 7 |
| Base material layer | | Base material | | (1) | (2) | (3) | (4) | (4) | (5) | (5) |
| | | Kind of | | PP/EVA/PP | PP/EVA/PP | PP/EVA/PP | PE/PP/PE | PE/PP/PE | TPU | TPU |
| | | base material | | | | | | | | |
| | | Thickness of base | μm | 150 | 200 | 300 | 150 | 150 | 100 | 100 |
| | | material | | | | | | | | |
| Pressure-sensitive | | Pressure-sensitive | | (1) | (1) | (1) | (1) | (2) | (1) | (1) |
| adhesive layer | | adhesive layer | | | | | | | | |
| | | Kind of pressure- | | Acrylic | Acrylic | Acrylic | Acrylic | Rubber- | Acrylic | Acrylic |
| | | sensitive adhesive | | | | | | based | | |
| | | layer | | | | | | | | |
| | | Thickness of | μm | 50 | 50 | 50 | 50 | 50 | 50 | 50 |
| | | pressure-sensitive | | | | | | | | |
| | | adhesive layer | | | | | | | | |
| Double-sided | | Total thickness | μm | 250 | 300 | 400 | 250 | 250 | 200 | 200 |
| pressure-sensitive | | | | | | | | | | |
| adhesive tape | | | | | | | | | | |
| Initial pressure- | 300 | To SUS | N/10 | 12.2 | 13.5 | 13.1 | 12.5 | 18.3 | 12.2 | 22.3 |
| sensitive | mm/min | | mm | | | | | | | |
| adhesive | 300 | To PP | N/10 | 3.6 | 2.3 | 2.4 | 2.6 | 11.0 | 2.1 | 14.8 |
| strength | mm/min | | mm | | | | | | | |
| | 300 | To polycarbonate | N/10 | 8.6 | 9.1 | 10.8 | 10.1 | 19.1 | 16.0 | 16.0 |
| | mm/min | | mm | | | | | | | |
| | 300 | To Cu | N/10 | 13.9 | 15.4 | 14.4 | 13.6 | 15.0 | 12.0 | 18.0 |
| | mm/min | | mm | | | | | | | |
| Shear adhesive | 10 | To SUS | MPa | 1.05 | 1.05 | 0.95 | 1.05 | 2.33 | 1.24 | 1.35 |
| strength | mm/min | | | | | | | | | |
| Tensile | 300 | | N/10 | 33 | 41 | 41 | 25 | 26 | 26 | 27 |
| strength | mm/min | | mm | | | | | | | |
| at elongation | | | | | | | | | | |
| of 600% | | | | | | | | | | |
| Elongation | 300 | | % | 669 | 812 | 885 | 682 | 1,004 | 1,015 | 902 |
| at break | mm/min | | | | | | | | | |

| | | | | | | | | |
|---|---|---|---|---|---|---|---|---|
| Reworking | Peelability | ∘ | ∘ | ∘ | ∘ | ∘ | ∘ | ∘ |
| property | Damage to copper foil | ∘ | ∘ | ∘ | ∘ | ∘ | ∘ | ∘ |
| | Peeling performed plurality | ∘ | ∘ | ∘ | ∘ | ∘ | ∘ | ∘ |
| | of separate times | | | | | | | |

| | | | | | | | | | Compar- | Compar- |
|---|---|---|---|---|---|---|---|---|---|---|
| | | | | | | | | | ative | ative |
| | | | | Example | Example | Example | Example | Example | Example | Example |
| | | | | 8 | 9 | 10 | 11 | 12 | 1 | 2 |
| Base material layer | | Base material | | (6) | (7) | (7) | (7) | (7) | (8) | (1) |
| | | Kind of | | TPU | SEBS•EVA | SEBS•EVA | SEBS•EVA | SEBS•EVA | Polyurethane | PP/EVA/PP |
| | | base material | | | | | | | | |
| | | Thickness of base | μm | 60 | 150 | 150 | 150 | 150 | 190 | 150 |
| | | material | | | | | | | | |
| Pressure-sensitive | | Pressure-sensitive | | (3) | (1) | (4) | (5) | (2) | (1) | (6) |
| adhesive layer | | adhesive layer | | | | | | | | |
| | | Kind of pressure- | | Acrylic | Acrylic | Rubber- | Rubber- | Rubber- | Acrylic | Acrylic |
| | | sensitive adhesive | | | | based | based | based | | |
| | | layer | | | | | | | | |
| | | Thickness of | μm | 95 | 50 | 50 | 50 | 50 | 50 | 50 |
| | | pressure-sensitive | | | | | | | | |
| | | adhesive layer | | | | | | | | |
| Double-sided | | Total thickness | μm | 250 | 250 | 250 | 250 | 250 | 250 | 250 |
| pressure-sensitive | | | | | | | | | | |
| adhesive tape | | | | | | | | | | |
| Initial | 300 | To SUS | N/10 | 8.7 | 20.2 | 5.6 | 7.0 | 12.0 | 13.5 | 15.5 |
| pressure- | mm/min | | mm | | | | | | | |
| sensitive | 300 | To PP | N/10 | 3.8 | 11.6 | 9.0 | 6.0 | 13.4 | 2.6 | — |
| adhesive | mm/min | | mm | | | | | | | |
| strength | 300 | To polycarbonate | N/10 | 8.1 | 20.8 | 12.6 | 7.0 | 20.3 | 4.8 | — |
| | mm/min | | mm | | | | | | | |
| | 300 | To Cu | N/10 | 11.2 | 18.4 | 12.0 | 7.6 | 16.3 | 8.3 | — |
| | mm/min | | mm | | | | | | | |
| Shear adhesive | 10 | To SUS | MPa | 0.66 | 2.22 | 1.23 | 0.9 | 1.09 | 1.05 | 1.45 |
| strength | mm/min | | | | | | | | | |
| Tensile | 300 | | N/10 | 33 | 33 | 28 | 20 | 30 | 112 | 30 |
| strength | mm/min | | mm | | | | | | | |
| at elongation | | | | | | | | | | |
| of 600% | | | | | | | | | | |
| Elongation | 300 | | % | 600 | 709 | 645 | 682 | 665 | 879 | 906 |
| at break | mm/min | | | | | | | | | |

| | | | | | | | | |
|---|---|---|---|---|---|---|---|---|
| Reworking | Peelability | ∘ | ∘ | ∘ | ∘ | ∘ | x | x (broke) |
| property | Damage to copper foil | ∘ | ∘ | ∘ | ∘ | ∘ | x | ∘ |
| | Peeling performed plurality | ∘ | ∘ | ∘ | ∘ | ∘ | ∘ | ∘ |
| | of separate times | | | | | | | |

### INDUSTRIAL APPLICABILITY

The double-sided pressure-sensitive adhesive tape in the embodiment of the present invention is utilized for, for example, fixing or temporarily fixing a part to be included in an electronic device, typically a mobile device, such as a cellular phone, a smartphone, or a tablet terminal.

### REFERENCE SIGNS LIST

10 base material layer (A)
21 pressure-sensitive adhesive layer (B1)
22 pressure-sensitive adhesive layer (B2)
200 double-sided pressure-sensitive adhesive tape

1. A double-sided pressure-sensitive adhesive tape, comprising, in this order:
a pressure-sensitive adhesive layer (B1);
a base material layer (A); and
a pressure-sensitive adhesive layer (B2),
wherein the pressure-sensitive adhesive layer (B1) and the pressure-sensitive adhesive layer (B2) each contain at least one kind selected from the group consisting of: an acrylic pressure-sensitive adhesive; and a rubber-based pressure-sensitive adhesive, the acrylic pressure-sensitive adhesive containing a filler,
wherein the base material layer (A) contains, as a resin component, at least one kind selected from the group consisting of: polyolefin; thermoplastic polyurethane; and a styrene-based polymer,
wherein the pressure-sensitive adhesive layer (B1) and the pressure-sensitive adhesive layer (B2) each have an initial pressure-sensitive adhesive strength to a SUS plate of 5 N/10 mm or more at a peel angle of 180° and a peel rate of 300 mm/min under an environment at 23° C. and 50% RH, the initial pressure-sensitive adhesive strength being specified in JIS-Z-0237-2000, and
wherein the double-sided pressure-sensitive adhesive tape has an elongation at break of 600% or more, which is measured by a method of measuring an “elongation” specified in JIS-K-7311-1995.

2. The double-sided pressure-sensitive adhesive tape according to claim 1, wherein the double-sided pressure-sensitive adhesive tape has a tensile strength of 12 N/10 mm or more at an elongation of 600%, the elongation being measured by the method of measuring an “elongation” specified in JIS-K-7311-1995.

3. The double-sided pressure-sensitive adhesive tape according to claim 1, wherein the base material layer (A) is a two-kind and three-layer type base material layer having a configuration “X layer/Y layer/X layer.”

4. The double-sided pressure-sensitive adhesive tape according to claim 3, wherein the two-kind and three-layer type base material layer is a two-kind and three-layer type base material layer having a layer configuration “polypropylene/ethylene-vinyl acetate copolymer/polypropylene,” or a two-kind and three-layer type base material layer having a layer configuration “polyethylene/polypropylene/polyethylene.”

5. The double-sided pressure-sensitive adhesive tape according to claim 1, wherein the double-sided pressure-sensitive adhesive tape has a total thickness of from 100 μm to 700 μm.

6. The double-sided pressure-sensitive adhesive tape according to claim 1, wherein the base material layer (A) has a thickness of from 20 μm to 500 μm.

7. The double-sided pressure-sensitive adhesive tape according to claim 1, wherein the pressure-sensitive adhesive layer (B1) and the pressure-sensitive adhesive layer (B2) each have a thickness of from 10 μm to 200 μm.

8. The double-sided pressure-sensitive adhesive tape according to claim 1, wherein the double-sided pressure-sensitive adhesive tape is used for an electronic device.
